(19) United States
(12) Patent Application Publication
(10) Pub. No.: US 2010/0070417 A1
(43) Pub. Date: Mar. 18, 2010

(54) NETWORK REGISTRATION FOR CONTENT TRANSACTIONS

(75) Inventors: Judson John Flynn, Decatur, GA (US); Erick John Haughn, Norcross, GA (US); John Lewis, Lawrenceville, GA (US)

Correspondence Address: AT&T Legal Department - T&W;Attn: Patent Docketing, Room 2A-207, One AT&T Way, Bedminster, NJ, 07921, US

(73) Assignee: AT&T Mobility II LLC, Atlanta, GA (US)

(21) Appl. No.: 12/209,819

(22) Filed: Sep. 12, 2008

(51) Int. Cl. H04L 9/00

(52) U.S. Cl. 705/51

(57) ABSTRACT

System(s) and method(s) are provided for registration of non-mobile devices with a mobile network platform for secure content transactions among the mobile network platform and registered non-mobile devices, and mobile and registered non-mobile devices. Through various secure protocols, a registration component within the mobile network platform records non-mobile devices provisioned through a non-mobile network platform. Recordation includes validation of devices associated with the non-mobile devices and retention of devices records. Content transaction(s), e.g., content delivery and exchange, are conducted securely, and abide by license terms for content dissemination. Content transaction(s) can be billed based at least in part on license terms, or subscriber intelligence. Transacted content can be received and formatted by a master non-mobile within a network of provisioned non-mobile devices. The master non-mobile device securely delivers transacted contents to slave non-mobile devices and to the mobile network platform. Advertisement(s) also can be transacted.

### TECHNICAL FIELD

The subject innovation relates to networked communications and, more particularly, to registration of a non-mobile device with a mobile network for secure content transactions among the mobile network and registered non-mobile devices, and mobile and registered non-mobile devices.

### BACKGROUND

Technological advances have provided various sectors of society like government, industry, health care, law enforcement and security, education, commerce and entertainment with access to networked information in order to increase operational and commercial efficiencies. Illustrative examples of such efficiencies are centralized billing; on-demand services; centralized content storage; access to cross-linked, network-wide databases; always-on access to service(s) and content(s); and so forth. Networks of devices, mobile or otherwise, within one or more sectors consume and generate information that is retained within the network. Networked devices within a network typically are provisioned through a specific network platform, wherein the network platform generally administers information access among the devices. Even though various sectors can share information, the networked information is primarily accessed vertically; namely, devices within a network platform can access content straightforwardly whereas cross-network platform information exchange is substantially mitigated. Thus, management of content within a network is generally referred to as obeying a “silo” paradigm of content dissemination and access.

Such a silo paradigm can largely hinder operational and commercial synergies in connection with the foregoing efficiencies among a mobile network platform and a non-mobile network platform. In addition, such synergies can be further mitigated as a result of the silo paradigm typically leading mobile devices provisioned through a mobile network to consume or exploit content(s), such as media, in a manner (e.g., content format and delivery, billing structure, subscriber management, content and subscriber security, . . . ) that is substantially distinct from traditionally non-mobile devices provisioned through a non-mobile network.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject innovation provides system(s) and method(s) for registration of non-mobile devices with a mobile network platform for secure content transaction(s) among the mobile network platform and registered non-mobile devices, and mobile and registered non-mobile devices. Non-mobile devices can be stationary (e.g., a personal computer, or digital video recorder), and are provisioned through a non-mobile network platform. Devices can have distinct functionalities geared to disparate operational environments and conditions (e.g., industrial, medical, personal . . . ). Through various secure protocols such as Internet Protocol Security (IPsec), Secure Socket Layer (SSL), Transport Layer Security (TLS), Secure Shell (SSH), Secure File Transport Protocol (SFTP), Secure Copy (SCP), etc., a registration component within the mobile network platform records non-mobile devices provisioned through a non-mobile network platform. Recordation includes validation of devices associated with the non-mobile devices and retention of devices records. Content transaction(s), e.g., content delivery and exchange, are conducted securely, and abide by license terms for content dissemination. Content transaction(s) can be billed based at least in part on license terms, and subscriber intelligence. Transacted content can be received and formatted by a master non-mobile device within a network of provisioned non-mobile devices. The master non-mobile device securely delivers transacted contents to slave non-mobile devices and to the mobile network platform. Advertisement(s) also can be transacted, and securely delivered as a part of a content(s) payload, or decoupled from content(s).

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF DRAWINGS

FIG. 1 is a block diagram of an example system that facilitates registration of non-mobile devices with a mobile network platform for secure content transaction(s) among the registered non-mobile devices and the mobile network platform, and mobile devices associated therewith in accordance with aspects described herein.

FIG. 2 illustrates an example embodiment of a component that facilitates registration and content transaction(s) with a mobile network platform in accordance with aspects described herein.

FIG. 3 is a block diagram of an example embodiment of a mobile network platform that facilitates registration of non-mobile devices provisioned through a non-mobile network, and content transaction(s) among the provisioned non-mobile devices and the mobile network platform in accordance with aspects described herein.

FIG. 4 is a block diagram of an example embodiment of a mobile network platform that facilitates registration of non-mobile devices provisioned through a non-mobile network, and content(s) and advertisement(s) transaction(s) among the provisioned non-mobile devices and the mobile network platform in accordance with aspects described herein.

FIGS. 5A and 5B illustrate, respectively, block diagrams of example embodiments of disparate non-mobile devices that can register with a mobile network platform, and transact content(s) therewith in accordance with aspects described herein.

FIG. 6 illustrates a block diagram of an example embodiment of a format component that can operate in a master non-mobile device in accordance with aspects described herein.

FIGS. 7A-7C illustrate diagrams of example display user interfaces for non-mobile devices registered with a mobile network platform and mobile devices served thereby in accordance with aspects described herein.

FIG. 8 is a flowchart of an example method for recording non-mobile devices to conduct content transaction(s) according to aspects described herein.

FIG. 9 is a flowchart of an example method for delivering licensed contents to a destination device according to aspects described herein.

FIG. 10 is a flowchart of an example method for pushing, or delivering, advertisement(s) to a destination device according to aspects described herein.

FIG. 11 is a flowchart of an example method for registering and conducting content transaction(s) with a mobile network platform according to aspects described herein.

FIG. 12 is a flowchart of an example a method for exchanging content(s) transacted with a mobile network platform according to aspects described herein.

FIG. 13 illustrates a block diagram of an example embodiment of a mobile that can exchange content(s) with a non-mobile device registered with a mobile network platform in accordance with aspects described herein.

FIG. 14 is a block diagram of an example embodiment of a non-mobile device, which can be provisioned through a non-mobile network platform, and can operate as either a master device or a slave device is accordance with aspects described herein.

FIG. 15 presents a block diagram of an example embodiment of a mobile network platform which can register non-mobile devices and administer content transaction(s) in accordance with aspects described herein.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” “service,” “framework,” “interface,” “node,” and the like are intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment,” “mobile station,” “mobile,” subscriber station,” “access terminal,” “terminal,” “mobile handset,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B.” “evolved Node B,” “home Node B (HNB),” and the like, are utilized interchangeably in the subject application, and refer to a wireless network component or appliance that serves and receives data, control, voice, video, sound, gaming data, or substantially any data-stream or signaling-stream from a set of subscriber stations. Data (e.g., content or directives) and signaling streams can be packetized or frame-based flows.

Furthermore, the terms “user,” “subscriber,” “customer,” “consumer,” “agent,” and the like are employed interchangeably throughout the subject specification, unless context warrants particular distinction(s) among the terms. It should be appreciated that such terms can refer to human entities or automated components supported through artificial intelligence (e.g., a capacity to make inferences based on complex mathematical formalisms) which can provide simulated vision, sound recognition, and so forth.

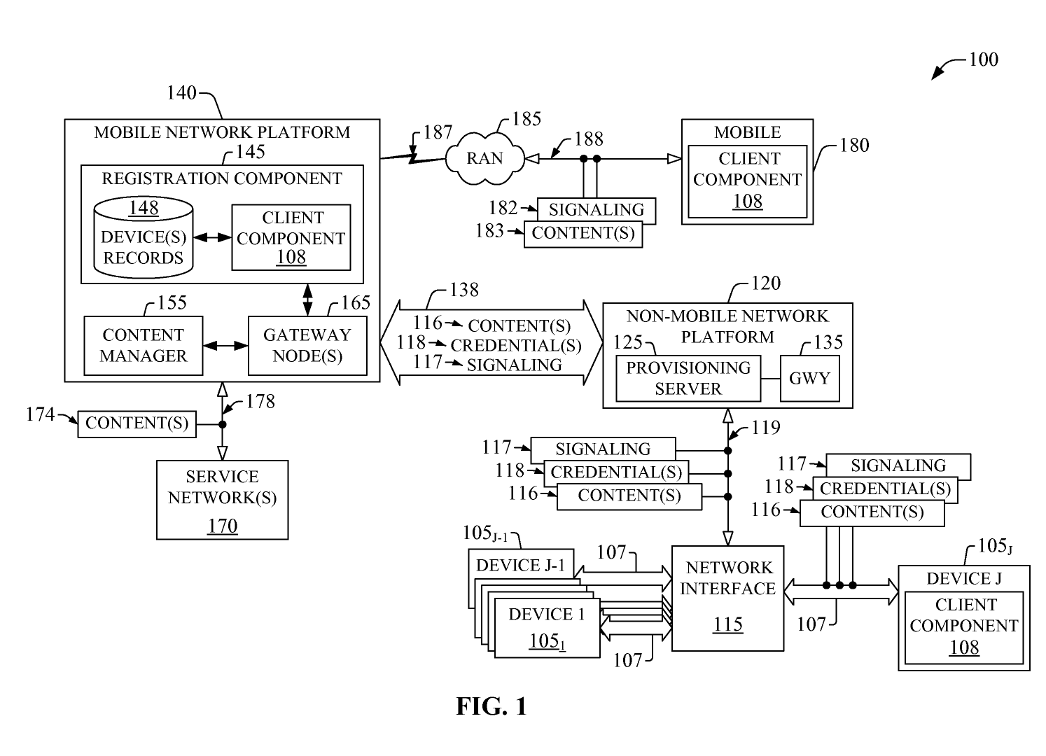

FIG. 1 is a block diagram of an example system 100 that facilitates registration of a set of non-mobile devices 105₁-105_{J} (J is a positive integer) with a mobile network platform 140 for secure content transactions among the registered non-mobile devices 105₁-105_{J} and the mobile network platform 140 and mobile devices associated therewith like mobile 180. Example system 100 also facilitates content transactions among the devices within the set of registered non-mobile devices 105₁-105_{J}. Content transaction(s) includes exchange of content (e.g., movies, television (TV) shows, or photos) originated within mobile network platform 140 and non-mobile devices 105₁-105_{J}, and remote exchange of existing content (e.g., movies, TV shows, or photos) among non-mobile devices and a mobile 180, or among devices within the set of non-mobile devices 105₁-105_{J}. In addition, content transaction(s) can include content access or delivery.

A provisioning server 125 in a non-mobile network platform 120 provisions non-mobile devices 105₁-105_{J}. In an aspect, upon provisioning a non-mobile device, provisioning server 125 can convey signaling 117 to mobile network platform 140 that indicates the provisioned device has elected to perform content transaction(s) therewith. Upon receiving such signaling 117, mobile network platform 140 can create security credential(s), or credential(s), 118 for the provisioned non-mobile device; such credential(s) 118 can be conveyed to non-mobile network platform 120 and relayed to the non-mobile device. In an aspect, security credential(s) are created by registration component 145. Alternatively, provisioned non-mobile devices can signal via signaling 117 to revoke such election at a later time, and reinstate it at a further later time. Non-mobile network platform 120 can include one or more of a telephony network (e.g., public switched telephony network (PSTN); an internet protocol-based network (e.g., internet service network, IP multimedia service network); a broadband network (e.g., DSL internet service network, cable television network); a local area network (e.g., enterprise networks like industrial machinery networks, hospital instrument networks).

Devices 105₁-105_{J} can include wireless or tethered devices, which can be located is disparate locations within a service area (e.g., a residential, commercial, or industrial building, a hospital, and so forth). A device is typically an electronic appliance with a set of specific enabled or capable functionalities (e.g., communication-oriented, control-oriented, image and sound display-oriented, computation-oriented, storage oriented . . . ), and operational resources (e.g., display size and type, computing power associated with a processor like a computing processing unit or graphic processing unit that resides within the device; memory structure and type (e.g., hard-drive aspects) determined at least in part by a memory present in the device; access to peripherals; and so on. It should be appreciated that a single device can combine various functionalities. In an aspect, a device implements its one or more functionalities through a set of components to which a processor, assisted through memory element(s), confers at least part of their functionalities. Illustrative examples of devices are tethered devices like a personal computer (PC), a digital video recorder (DVR), a voice over internet protocol telephone, an internet-protocol television (IPTV) display set, a digital camera, an audio-visual or data projector, a television set, a gaming console either wired or wirelessly connected (e.g., through link 107) to a network platform (e.g., non-mobile network platform 120) via a network interface (e.g., network interface 115). In addition, devices can also include industrial manufacturing and processing components such as miniaturized solid-state electronics deposition (e.g., molecular beam epitaxy, chemical vapor deposition) and processing (e.g., photolithographic equipment) chambers; high-pressure chambers, or isolation and containment chambers; welding and painting robots; assembly robots; food processing components such as freezing tunnels and chambers; pipelines flow controllers; annealing, melting or cooking ovens; transportation and product separation conveyers; and so on. Moreover, depending on network platforms, devices can include health performance indicator monitors; ultrasound, echography, endoscopy, and radiology equipment; infant incubator monitoring equipment; and so on.

In system 100, devices 105₁-105_{J} can communicate through a network interface 115, which communicates with non-mobile network platform 120 via link 119, which can be wireless or wired and includes uplink and downlink elements. In an aspect, wired links can include a T1/E1 phone line; a digital subscriber line (DSL) either synchronous or asynchronous; an asymmetric DSL (ADSL); an optical fiber backbone; a coaxial cable, etc., whereas wireless links can be line-of-sight (LOS) links or a non-LOS links, which can include terrestrial air-interfaces or deep space links. Devices attached to network interface 115 can be linked thereto via a wired or wireless link component 107: A wired link component 107 can include single- or multi-line twisted-pair lines, such a FireWire bus; a general purpose interface bus (GPIB) line; Universal Serial Bus (USB) connectors, recommended standard (RS)-232 connectors; Ethernet connectors; digital visual interface (DVIs) cables; high-definition multimedia interface (HDMI) cables and so forth. Wireless link component 107 can include LOS links such as wireless infrared (IR); or non-LOS links.

Mobile network platform 140 can include mobile networks that operate in accordance with one or more telecommunication technologies: For example, Third Generation Partnership Project Universal Mobile Telecommunication System (3GPP UMTS), Enhanced Data Rate for Global System for Mobile Communications (GSM) Evolution (EDGE), 3GPP Long Term Evolution (LTE), Wideband Code Division Multiple Access (W-CDMA), Ultra-broadband Mobility (UMB), Worldwide Interoperability for Microwave Access (WiMax), Wi-Fi. It is to be noted that mobile network platform 140 (e.g., a core network in 3GPP cellular telecommunication technology) has an associated radio access network (RAN) 185 which can include various base stations and access points for substantially any type of over-the-air coverage (e.g., disparate multiplexing and modulation schemes, and various modes for data stream delivery like multiple-input multiple output mode) with disparate spatial extents, e.g., macro (typically outdoors), micro (confined outdoor spaces like parking lots, or indoor spaces such as a library, a hospital, a retail store, a residence . . . ), or femto cell (indoor spaces) coverage, or any combination thereof. Base stations and access points within RAN 185 communicate with mobile network platform through link 187, which can include wired link components like T1/E1 phone line; a digital subscriber line (DSL) either synchronous or asynchronous; an asymmetric DSL (ADSL); an optical fiber backbone; a coaxial cable, etc.; and wireless link components such as line-of-sight (LOS) or non-LOS links which can include terrestrial air-interfaces or deep space links (e.g., satellite communication links for navigation). Additionally, in an aspect of the subject innovation, a mobile network platform(s) that facilitates wireless communication includes components, e.g., nodes, gateways, and interfaces that facilitate packet-switched (PS) (e.g., internet protocol (IP), asynchronous transfer mode (ATM) cell relay protocol) and circuit-switched (CS) traffic and control generation for networked wireless communication through one or more technologies.

Mobile 180 can be substantially any user equipment that includes a system identity module (SIM) card. In addition, mobile 180 can operate in various modes of communication (e.g., W-CDMA, UMB, 3GPP LTE, WiFi, WiMax . . . ). Mobile 180 is connected to RAN 185 through wireless link 188, which includes uplink and downlink elements.

It should be appreciated that non-mobile network platform 120 and mobile network platform 140, including associated RAN 185, can be operated by a single service provider. Additionally, it is to be noted that both mobile network platform 140 and non-mobile network platform 120 include components that facilitate data generation and delivery in accordance with modulation and multiplexing modes specific to the type of service(s) provisioned by each of the network platforms. In particular, network platforms 140 and 120 can include application server(s), billing component(s), operation and maintenance component(s), interfaces between data generation components (e.g., cameras that capture live events such as a football game, a political speech, a surgical procedure that is part of a remote surgery event . . . ) and data delivery components, and so on. Processors (not shown) that generally reside within each of mobile network platform 140 and non-mobile network platform 120 typically provide, at least in part, the functionality of substantially any component within the respective mobile or non-mobile network platforms, while memory elements (not shown) can retain data structures, code instructions, and algorithms related to such functionality; the processor is configured to exploit contents (e.g., execute code instructions) that reside within the memory in order to provide specific functionality to the mobile network platform 140 or non-mobile network platform 120.

In an aspect of the subject innovation, to register a set of non-mobile devices 105₁-105_{J} with mobile network platform 140 once the set of devices has been provisioned, a device (e.g., device 105_{J}) in the set of non-mobile devices conveys security credentials, or credentials, associated with the set of provisioned non-mobile devices to non-mobile network platform 120, which relays the credential(s) 118 to mobile network platform 140. Credential(s) 118 are relayed through link component 138, which can have substantially the same physical and functional characteristics as link 119 or substantially any link in example system 100. A registration component 145 receives and centrally validates the credential(s) 118; a client component 108 that can reside within registration component 145 conducts the validation. Credential(s) 118, and signaling 117 associated with establishment of a secure connection, are typically received through gateway node(s) 165. In an aspect of the subject innovation, registration component 145 can act as a certificate authority, which can generate and receive certificates associated with each device in the subset of devices 105₁-105_{J} and verify the certificates—certificates, or digital certificates, are typically electronic credentials (e.g., codes, labels, tokens, lightweight files, encrypted or otherwise) that are used to certify identities of components in a network (e.g., servers, peripherals, etc) and operator agents as well. Generation of certificates can be requested for the set of non-mobile devices 105₁-105_{J} through signaling 117 conveyed by the device 105_{J}.

Once a device in the subset of provisioned non-mobile devices 105₁-105_{J} is recorded with registration component 145, the device can conduct secure content transaction(s) with mobile network 140 and service network(s) 170 (e.g., an internet protocol multimedia subsystem (IMS)) associated therewith; it should be appreciated that IMS can serve landline and wireless client devices. Moreover, secure content transaction(s) can be conducted among the recorded non-mobile devices and mobile devices (e.g., mobile 180) served by mobile network platform 140 or disparate recorded non-mobile devices. With respect to mobile devices, secure content transaction(s) (e.g. delivery and exchange of content(s) 183) and delivery of signaling 182 can be afforded via a client component 108 in each of the mobile devices in accordance with security protocols that can ensure secure communication among a mobile device and non-mobile devices registered with the mobile network platform 140 that serves the mobile device (e.g., mobile 180). The foregoing secure communication among a mobile device and a mobile network platform can be an additional security layer over substantially any security mechanism or layer provided conventionally through communication among the mobile device and the mobile network platform. For recorded non-mobile devices 105₁-105_{J}, a recordation indication (e.g., a predetermined multi-bit word in a specific memory register, or a recordation system file) and identifying non-mobile device information (e.g., a serial number or product code that identifies the non-mobile device(s)) that complements the non-mobile device(s)'s credentials can be stored in device(s) records storage 148. Additionally, technical specifications of registered non-mobile devices also can be retained in device(s) records 148. In an aspect, device(s) records 148 can be at least a part of a home location register (HLR) associated with the mobile network platform 140.

It should be appreciated that, in an alternative or additional aspect of the subject innovation, registration component 145 can reside within a service node or infrastructure (e.g., IMS) within service network(s) 170, wherein a non-mobile device (e.g., device J 105_{J}) can establish a secure connection (e.g., an internet protocol connection) with the registration component 145 and register a set of non-mobile devices 105₁-105_{J}. Signaling 117 associated with establishing the secure communication can be conveyed to the service node or infrastructure through gateway node(s) 165 via link component 178. It is to be noted that when the service infrastructure that provides content (e.g., multimedia content(s)), device(s) records 148 can be a part of a home subscriber server (HSS).

Registration of provisioned non-mobile devices (e.g., devices 105₁-105_{J}) with a mobile network platform (e.g., mobile network platform 140) as described in the subject innovation provides at least three advantages: (i) Through a non-mobile device recordation indication in a device(s) records storage 148 (e.g., at least a portion of HLR or HSS), it is conveyed to the mobile network platform 140 that it is safe to conduct content transaction(s). In addition, the recordation indication provides an instrument for monetization and implementation of various pricing schemes, e.g., pricing differentiation such as segmented or promotional pricing, for content transaction(s) that include recorded non-mobile devices. (ii) Licensed or protected content can retained and disseminated within a single network, administered by a single network operator, that includes a mobile network, e.g., mobile network platform 140 and RAN 185, and a non-mobile network platform (e.g., non-mobile network platform 120) that provisions the non-mobile recorded devices (e.g., devices 105₁-105_{J}), and subscribers of the single network as well. Moreover, as registration confers approval of non-mobile subscribers and authorized mobile subscriber, transation(s) of licensed or unlicensed content(s) is enhanced through reduction of the numbers of events necessary to validate a subscriber that exchanges content on either a chargeable or free-of-charge basis. (iii) Services directed primarily to mobile devices can be seamlessly and securely extended to, and consumed by, non-mobile device provisioned through a non-mobile network platform (e.g., a broadband network). In an aspect, advantages (i) and (ii) can be effected through a content manager 155 that resides within mobile network platform 140 and implements content transaction(s) billings and licensing enforcement.

As an example of content transaction(s) facilitated by registration of non-mobile devices (e.g., devices 105₁-105_{J}), multimedia content generated through one or more services, or service applications, such as an IMS-based multimedia (e.g., streaming video or sound) sharing platform (e.g., AT&T VideoShare) within service network(s) 170 can be delivered securely through mobile network platform 140 (e.g., cellular 3GPP UMTS network, or a Wi-Fi network, or a femto cell network) to one or more registered non-mobile devices like a PC, an IPTV display set, or a DVR provisioned through non-mobile network platform 120 which can be a broadband network (e.g., DSL network) that delivers packetized traffic or data streams. In addition, secure exchange of pre-recorded content(s) (e.g., feature movies in Moving Picture Experts Group Phase 4 (MPEG-4), recommendation (Rec.) 601, or substantially any other video format; photos in Joint Photographic Experts Group (JPEG) format or substantially any digital frame image format; MPEG-1 audio layer 3 (MP3) files; recorded television shows . . . ) across non-mobile devices (e.g., devices 105₁-105_{J}) and mobile devices (e.g., mobile 180) can be accomplished. It should be appreciated that registered non-mobiles devices that engage in a content transaction can be an industrial equipment or medical device when non-mobile network platform 120 is embodied, respectively, in a factory plant or hospital network. As an example, protected content pre-recorded or streaming (e.g., content 117), captured through a medical instrument such as ultrasound equipment (e.g., device 105₁) provisioned through a non-mobile hospital network (e.g., non-mobile network platform 120), can be conveyed securely to a mobile station (mobile 180) operated by a physician associated with the protected content. As indicated above, the mobile station in the foregoing example can be further secured, via a security protocol, with the mobile network platform that serves the mobile station in order to safely receive the protected content(s) (e.g., contents 183) from the registered medical instrument or substantially any other recorded non-mobile device.

It should be appreciated that registration of a set of provisioned non-mobile devices and content transaction(s) effected thereafter, can be implemented within a master-device-slave-device wherein a single, master device (e.g., device J 105_{J}) conveys credential(s) 118 and signaling 117, and conveys and receives content(s) associated or directed to one or more slave non-mobile provisioned devices (e.g., devices 105₁-105_{J-1}). The master device includes a client component 108 that affords implementation of secure communication with mobile network platform 140 and slave non-mobile devices. In an aspect, a master non-mobile device can be configured through provisioning server 125, and the master non-mobile device (e.g., device J 105_{J}) can configure non-mobile devices as slave devices. Through client component 108, the master device gathers credential(s) 118 associated with disparate non-mobile devices. At least one advantage of a master-device-slave-device scheme is that a non-mobile device with substantially more computational resources (e.g., processor speed and available memory) than other provisioned non-mobile devices can be employed for communication and processing (e.g., signaling 117) associated with registration and content transaction(s). Thus, exploitation of legacy non-mobile devices, or non-mobile devices with limited computational resources, can be straightforwardly commanded through the master non-mobile device.

It should be appreciated that one or more slave devices can also include a client component 108. In addition, it is to be noted that network interface 115 can reside within a master device, e.g., device J 105_{J}, even though in example system 100 the network interface 115 is external to the master device. Additionally, in an aspect, a master device can be distributed, wherein a subset of the set of provisioned non-mobile devices can embody the master device.

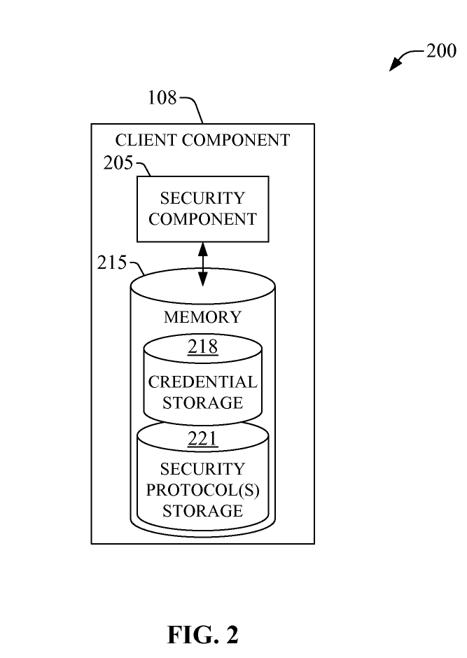

FIG. 2 is an example embodiment 200 of a client component 108 that facilitates content transaction(s) with a mobile network platform (e.g., mobile network platform 140) or across networked non-mobile devices (e.g., devices 105₁-105_{J}) provisioned through a non-mobile network platform (e.g., non-mobile network platform 120). Client component 108 can employ security component 205 to securely deliver and receive content(s), credential(s), and signaling via a link component (e.g., link 107, link 138, or link 178). Signaling can comprise (i) instructions, requests, indications, and the like, to implement at least in part secure attachment, or connection establishment, and content transaction(s); and (ii) data (e.g., IP addresses) that provide routing information, such as logical addresses of access ports, associated with a non-mobile device, or other identification information thereof. In addition, client component 108 includes memory 215, which can comprise credential storage 218 (e.g., a register or a stack) and security protocol(s) storage 221 (e.g., a register or a stack). A processor (not shown) can provide at least in part the functionality of client component 108 and components that reside thereon.

To facilitate secure delivery, security component 205 administers secure attachment, or connection establishment, with a mobile network platform or provisioned non-mobile devices. To implement secure attachment, and content transaction(s), e.g., exchange of content(s) 116 with mobile network platform 140, security component 205 can utilize a set of security protocols, or mechanisms, which can be retained in security protocols(s) storage 221. In addition, security component 205 can exploit security credentials, or credentials, that reside in credential storage 218. Credential(s) can include substantially any code or token, or light weight file (e.g., a digital certificate) that identifies a device uniquely; for instance, passwords, public and private encryption keys, etc. Security protocols can include at least one of encryption, password protection, or biometric locking (e.g., information access through an authorized or registered biometric instrument like fingerprint(s) or iris pattern, voice profile, or any combination thereof). As an example, security protocols retained in security protocol(s) storage 221 can include, but are not limited to, Internet Protocol Security (IPsec), Secure Socket Layer (SSL), Transport Layer Security (TLS), Secure Shell (SSH), Secure File Transport Protocol (SFTP), Secure Copy (SCP), and so forth. It is to be noted that security component 205 can exploit one or more of the illustrative security protocols to establish a virtual private network (VPN) for device-to-device or platform-to-device tunnel of content(s) (e.g., content(s) 116) and signaling (e.g., signaling 117) associated with content transaction(s) described herein.

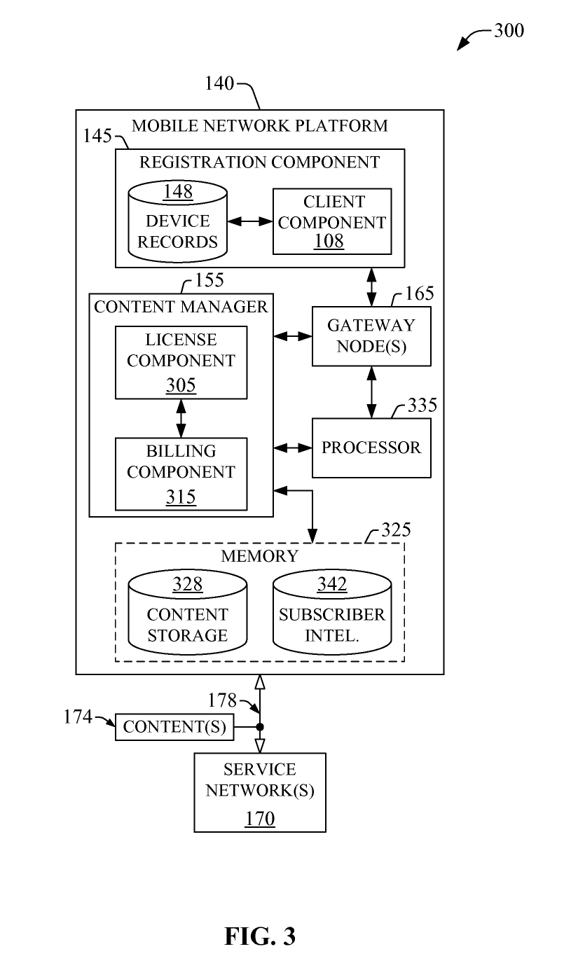

FIG. 3 is a block diagram of an example embodiment 300 of a mobile network platform 140 that facilitates registration of non-mobile devices provisioned through a non-mobile network platform, and content transaction(s) among the provisioned non-mobile devices and the mobile network platform 140. It is noted that in example embodiment 300, components and elements with like numerals as in previously discussed embodiments or example systems possess substantially the same functionality and operate in substantially the same manner as previously described.

With respect to content manager 155 in example embodiment 300, a license component 305 enforces license aspects of content(s) (e.g., content(s) 116) that is transacted among the mobile network platform 140 and registered non-mobile devices, or content(s) that are exchanged among a mobile device and non-mobile devices (e.g., devices 105₁-105_{J}). In addition, license component 305 can tag content(s), e.g., enter a set of bits in the header of each data packet that transports such content(s), according to its license to ensure dissemination abides by the license terms (e.g., license-free content, GNU General Public License, trial-term license, multi-user license, single-device license, copyrighted content, and so forth) and facilitate license tracking. In addition, license manager 155 can convey license terms for transacted content(s).

Content manager 155 also can include a billing component 315 that issues or processes charges for transacted content(s) that are billable, like content(s) 174 generated by service network(s) 170. Billing component 315 can implement billing schemes based at least in part upon negotiated license rights to transacted content(s); for instance, mobile network platform can license movies from a motion picture studio, or songs from a specific artist affiliated with a record label, and deliver such content(s) free of charge, at a flat fee for a specific number of content transaction(s) or for a specific time interval to transact content(s). It should be appreciated that the terms of such license agreement(s) can be enforced or enacted by license component 305. Billing component 315 can exploit subscriber intelligence 342, stored in memory 325, to bill a subscriber associated with a non-mobile device that transacts content(s): The subscriber can be billed in accordance with a subscriber profile which can include subscriber commercial history which in turn can determine, for example, whether the subscriber is credit worthy; or subscriber payment preferences (e.g., pay-per-view, subscription . . . ). In addition, billing component 315 can administer promotional billing (e.g., discounted price, free-of-charge) for specific content(s) (e.g., content(s) 174 generated via service network(s) 170) or for specific subscribers.

Additionally, content manager 155 can transact content(s) retained in content storage 328 that resides within memory 325. Such content(s) can be available on an on-demand basis to an end-user of a mobile device served through mobile network platform 140, and a set of networked non-mobile devices (e.g., devices 105₁-105_{J}) associated with the end-user. Moreover, content storage 328 can serve as a buffer for transacted content(s) directed to a registered non-mobile device or mobile device that is logically or physically inactive, e.g., at least a portion of the device, like a transceiver or an interface, is turned off or unable to communicate due to link failure, or a firewall on a device is set to reject substantially all incoming content(s). It should be noted that at least one advantage of content manager 155 retaining transacted content(s) in content storage 328 is that substantially any registered non-mobile device can appear as logically active to a mobile device (e.g., mobile 180), a service network(s) 170, a portion of mobile network platform 140, or a non-mobile device (e.g., device 1 105₁) at substantially all times, even though one or more of the registered non-mobile devices can be inactive.

It should be noted that in example embodiment 300 of mobile network platform 140, processor 335 provides at least in part the functionality of registration component 145 and component therein, content manager component 155 and component therein, and gateway node(s) 165 as well. Data structures, code instructions, and algorithms (not shown) related to such functionality can be stored in memory 325 and utilized by processor 335.

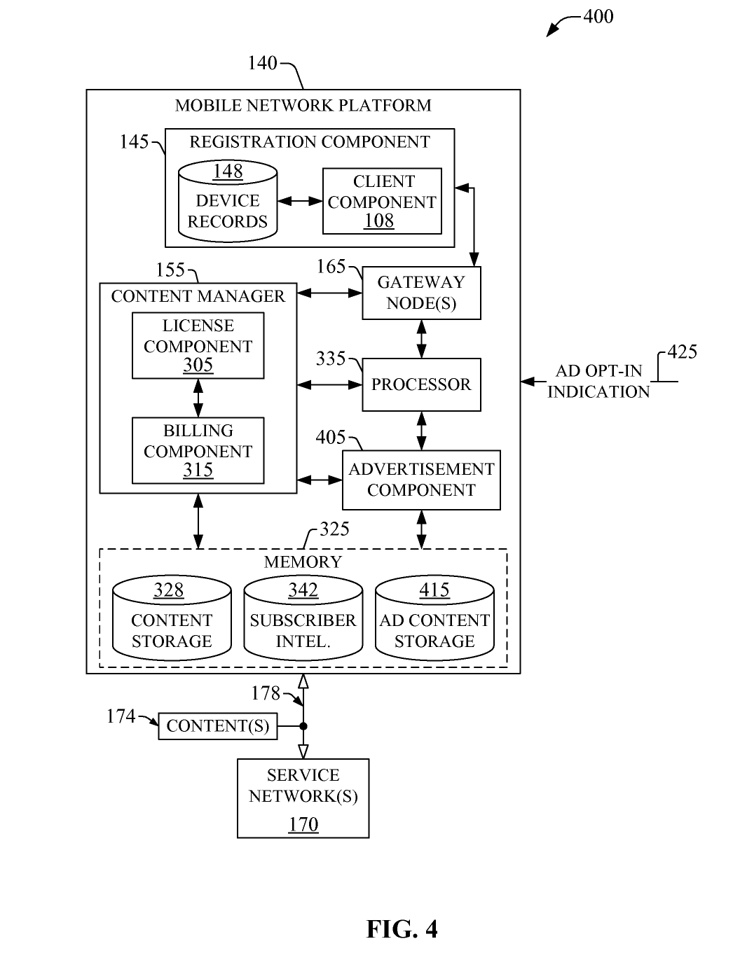

FIG. 4 is a block diagram of an example embodiment 400 of a mobile network platform 140 that facilitates registration of non-mobile devices provisioned through a non-mobile network, and content(s) and advertisement(s) transactions among the provisioned non-mobile device and the mobile network platform. It is noted that in example embodiment 400, components and elements with like numerals as in previously discussed embodiments or example systems possess substantially the same functionality and operate in substantially the same manner as previously described.

In example embodiment 400, an advertisement component 405 is functionally coupled to content manager 155. The advertisement component 405 can inject advertisement(s) into content(s) transactions among mobile network platform 140 and registered non-mobile devices, among networked registered non-mobile devices, and non-mobile and mobile devices as well. In an aspect, a non-mobile device that receives advertisement can elect to do so through communication of an advertisement opt-in indication 425, which can be signaled through signaling 117. The advertisement component 405 can select advertisement from ad content storage 415 in memory 325, based at least in part on transacted content(s), e.g., movies, games, music, television shows, protected trade-specific material (e.g., medical records and information, quarterly reports on business performance of an organization that exploits non-mobile network platform 120), and so forth. In addition, ad content selection can be based at least in part upon subscriber intelligence 342 (e.g., subscriber demographics, historic data on content(s) transactions, utilization and consumption of content(s) 174 generated through service network(s) 170, and so on), which can be used to segment a subscriber universe to target advertisement content. Moreover, advertisement content can be selected and optimized based at least in part on device(s) records 148, which can include technical specification(s) of registered non-mobile devices, and subscriber information associated with a device. It should be appreciated that optimization can include adjustment of advertisement(s) features such as music, language, venues displayed within an advertisement, etc. Optimization can be effected through artificial intelligence techniques as described below. Advertisement content storage 415 can include movie trailers, free songs of new music artists, coupons associated with products or services related to registered non-mobile devices, and so forth.

Advertisement component 405 can generate at least a portion of ad content retained in storage 415; however, service network(s) 170 also can generate advertisement. Alternatively, or in addition, community-based advertisement generated by end-users of registered non-mobile devices can be retained in ad content storage 415, and injected into content(s) transactions. As an example, community-based advertisement can be exploited in second-life scenarios wherein advertisement(s) is directed to subscribers' characters, rather than the subscribers themselves, as it can occur within a multiplayer online gaming application executed via a service node (e.g., IMS) within service network(s) 170.

It should be noted that in example embodiment 400 of mobile network platform 140, processor 335 provides at least in part the functionality of registration component 145 and component therein, content manager component 155 and components therein, gateway node(s) 165, and advertisement component 405 as well. Data structures, code instructions, and algorithms (not shown) related to such functionality can be stored in memory 325 and utilized by processor 335.

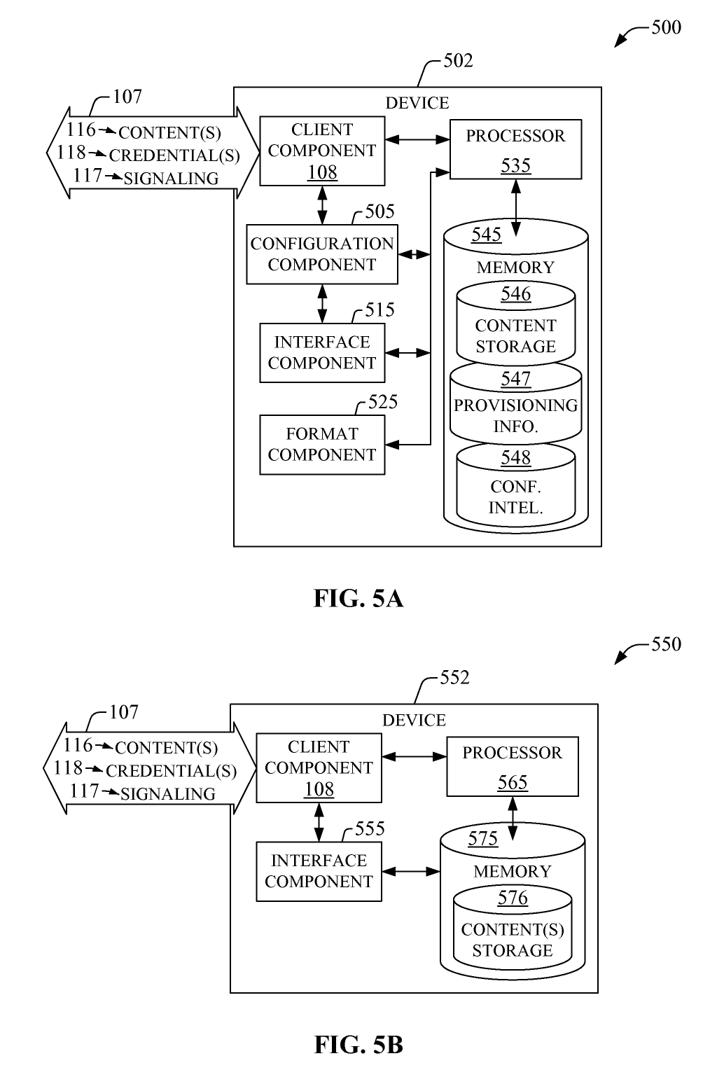

FIGS. 5A and 5B illustrate, respectively, block diagrams of an example embodiment 500 of a non-mobile device 502 and a mobile device 552 that can register with a mobile network platform (e.g., mobile network platform 140), and transact content(s) therewith. Non-mobile devices 502 and 552 have disparate operational resources, which render device 502 suitable to operate as a master device (e.g., device 105_{J} in example system 100), whereas device 552 can operate as a slave, or terminal, device (e.g., device 105₁ in example system 100) in accordance with aspects described above.

With respect to FIG. 5A, device 502 can act as a master non-mobile device that centralizes secure communication of content(s) 116, and transmission of signaling 117 and credential(s) 118 associated with a set of slave non-mobile device (e.g., 105₁-105_{J}). In an aspect, device 502 includes a client component 108 that can receive and deliver content(s) 116, signaling 117, and credential(s) 118 through link component 107. In an aspect, provisioning information (e.g., serial numbers, product code(s), routing information like logical addresses and data context, and so forth) associated with non-mobile devices can be signaled to master device 502, and retained in provisioning information storage, or provisioning information, 547.

Device 502 also includes a configuration component 505 that facilitates configuration of slave, or terminal, non-mobile devices. Configuration component 505 can be exploited through interface component 515; for instance, an icon within a display component that is part of interface component 515 can provide a graphic user interface or display user interface to effect configuration of a provisioned non-mobile device. Configuration of a slave non-mobile device (e.g., device J-1 105_{J-1}) can include collection of technical specifications of the configured device, and establishment of operational parameters of a device; such information, and related instructions for generation and manipulation thereof, can be conveyed as a part of signaling 117. Technical specification(s) captured through configuration can complement or supplement device specification(s) stored in provisioning information 547, particularly in a scenario in which one or more non-mobile devices are physically and logically upgraded. As mentioned above, a master device like 502 can be configured as such by provisioning server 125, based at least in part on non-mobile device's operational resources. Yet, configuration component 505 can also facilitate configuration of a slave or provisioned but yet non-configured non-mobile device into a master device, when operational resources of the device to be reconfigured afford to do so. Information collected on configured non-mobile devices and additional configuration information, e.g., reconfiguration criteria, configuration and operation log files . . . ), can be retained within configuration intelligence storage, or configuration intelligence, 548.

In device 502, client component 108 operates as described hereinbefore in connection with FIG. 2. In addition, client component 108 also can manage interaction with an end-user or agent via interface component 515. Information like signaling 117 and content(s) 116 generated through such interaction can be conveyed to, and utilized by, client component 108. In an aspect of the subject innovation, interface component 515, which can be accessed by an agent, can generate content(s) 116 and signaling 117 via various instruments (e.g., via a keyboard, touch screen, microphone, biometric pad, camera(s), speakers . . . ) for data input and data output. For example, a camera that resides in device 502 can embody, at least in part, a data entry interface which can be part of interface component 515; captured images (e.g., a static frame(s), or dynamic multi-frames or movie) with the camera can be conveyed securely by client component 108 via link component 107.

Interface component 515 can display, via visual or aural indicia, or tactile interaction such as touch-based navigation, content(s) that is available for content(s) transactions with a mobile network platform 140, or among non-mobile devices, or between mobile and non-mobile devices. Such a catalog of available content(s) can be rendered in accordance with various schemes (e.g., windows-based schemes such as iconic representation, pop-up representation; or text-based representation, with scroll-down or scroll-sideways delivery, or static rendering). Content(s) that are available for transaction or arise from a transaction can include image and movie files, sound files, text-based files, system and log files, and protected trade-specific which can be stored in a memory element such as content storage 546 within memory 545.

Content(s) 116 transacted with mobile network platform 140 can require format adaptation to optimally exploit resources of a non-mobile device that receives transacted content(s), and provide a rich user experience. Format component 525 can implement format adaptation as described in detail below.

It should be noted that in example embodiment 500 of a non-mobile device 502, processor 535 provides at least in part the functionality of client component 108, configuration component 505, interface component 515, format component 525, and substantially any component stored within such components. In addition to data and information described above, data structures, code instructions, and algorithms (not shown) related to such functionality can be retained in memory 545 and utilized by processor 535.

In connection with FIG. 5B, device 552 can act as a slave, or terminal, non-mobile device. In an aspect, device 552 includes a client component 108 that can deliver content(s) 116, signaling 117 and credential(s) 118 to a master non-mobile device (e.g., 502) through link component 107. Content(s) 116 can be retained in content(s) storage 576 in memory 575. Signaling 117 can convey device 552 technical specification(s), and indication(s) that device 552 is operationally inactive. Device 552 also includes an interface 555 which can facilitate interaction of an end-user with client component 108. In an aspect, interface component 555 can have substantially less operational resources, like data entry and display components, than interface component 515 associated with non-mobile device 502. Thus, in a master-device-slave-device scenario, once non-mobile device 552 is configured as a slave device, interaction of an end user or agent with client component 108 within device 552 can be accomplished through interface component 515. It should be appreciated that the lack of a configuration component or a format component reflects the slave, or terminal, character of device 552.

In example embodiment 550 of a non-mobile device 552, processor 565 can have less processing or computing power than processor 535; yet, processor 565 provides at least in part the functionality of client component 108 and interface component 555, and substantially any component stored within such components. In addition to content(s) 116, data structures, code instructions, and algorithms (not shown) related to such functionality can be retained in memory 575 and utilized by processor 565.

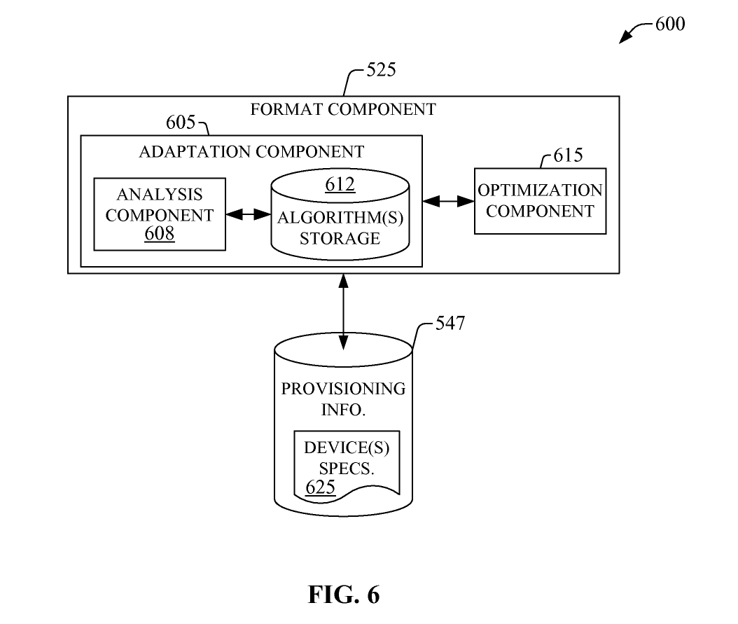

FIG. 6 illustrates a block diagram of an example embodiment 600 of a format component that can operate in a master non-mobile device like device 502 or 105_{J}. Format component 525 can include an adaptation component 605 that adjusts format of multimedia content exchanged among a set of provisioned non-mobile devices 105₁-105_{J} and a mobile network platform 140, or among devices within the set of non-mobile devices 105₁-105_{J}. Format of transacted content(s) 116 can be adjusted to one of a specific set of native formats of a destination device (non-mobile or mobile). Additionally, format of the transacted content(s) 116 can be optimized through an optimization component 615 that can determine format(s) that optimize perceived user experience, utilization of operational resources of a non-mobile or mobile device that receives the transacted content(s) 116, and so forth.

Analysis component 608 can receive a data stream and determine a specific format utilized for the received content(s) (e.g., MPEG-4, Rec. 601, MP3, and so on), and associated quantization such as color quantization, sound quantization, or data quantization, and compression scheme(s). In an aspect, analysis can be based on a set of received packets within a data stream and blind decoding with a set of hypothesis formats. It should be appreciated that a master non-mobile device (e.g., device J 105_{J}) can receive content(s) 116 in one or more formats compatible with operational resources (e.g., a video and sound grabber card). Once format has been determined, analysis component 608 can access technical device specifications 625 of the destination non-mobile device, which can be stored within provisioning information storage 547, in order to assess whether to upconvert or downcovert the resolution (e.g., number of received pixel per image) of received media, for example, in order to match available operation resources such as a display component within the device. Such conversion can be effected according to specific algorithms (e.g., inverse discrete cosine transform (DCT) with subsequent filtering) retained in an algorithm(s) storage 612. In addition, adaptation component 605 can utilize a determined format of transacted content(s) to resize data packet frames in accordance with native formats of a destination device (e.g., conversion from high bitrate to low bitrate data) or expected image and sound quality (e.g., constant bitrate to variable bit rate).

To automatically adapt or manipulate format of transacted content(s) 116, optimization component 615 can employ artificial intelligence. The term “intelligence” refers to the ability to reason or draw conclusions about, e.g., infer, the current or future state of a system based on available information about the system. Artificial intelligence (AI) can be utilized to identify a specific context or action, or generate a probability distribution of specific states of a system without human intervention. To infer optimal formats (e.g., data frame size, packet bitrate, etc) for transacted content(s) delivery in order to achieve optimal mobile or non-mobile device performance, optimization component 615 can rely on artificial intelligence techniques, which apply advanced mathematical algorithms—e.g., decision trees, neural networks, regression analysis, for configuration weight or probability determination; principal component analysis (PCA) for feature and pattern extraction, cluster analysis, genetic algorithm, and reinforced learning—to information on a set of content(s) data streams.

In particular, optimization component 615 can employ at least one of various methodologies for learning from data and then drawing inferences from the models so constructed, e.g., Hidden Markov Models (HMMs) and related prototypical dependency models, more general probabilistic graphical models, such as Dempster-Shafer networks and Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. The foregoing methods can be applied to identify (e.g., determine a statistical weight) different bitrates and compression schemes for video and sound streaming; pixel resolution; to increase user perceived experience, which can be measured via subscriber attrition rates and new-subscriber gains, for example; or to achieve optimal non-mobile device (e.g., device 1 105₁) performance or utilization of available operational resources thereof. Additionally, the foregoing techniques also can be exploited to optimize advertisement(s) contents.

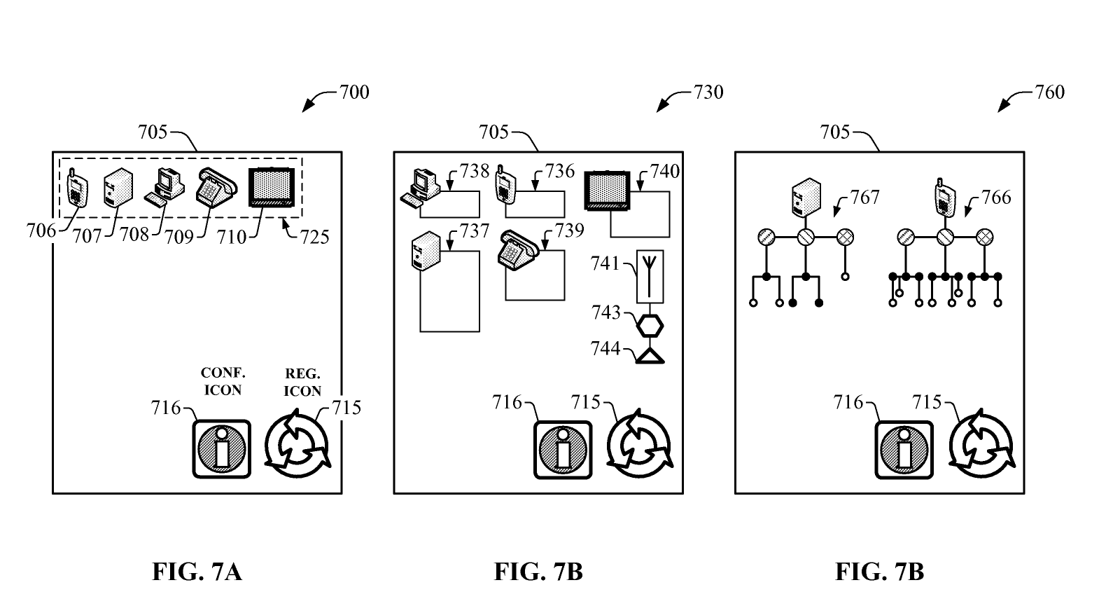

FIGS. 7A-7C illustrate diagrams of example display user interfaces (DUIs) that facilitate content transaction(s) in accordance with aspects described herein. A DUI is a part of interface component 515 or interface component 555, and aspects or features of a DUI are generally dictated by operational resources available to such interface components. For example, a DUI can be embodied in a display area in a monitor (e.g., a cathode ray tube (CRT) monitor, a Liquid Crystal Display (LCD) monitor, a plasma monitor, an electrochromic monitor, and so on) that renders video image(s) from IPTV stream(s) delivered through an IPTV interface, or images from a personal computer, or echography equipment, etc. FIG. 7A illustrates diagram 700 of a DUI that includes a rendering area 705 that displays a registration (reg.) icon 715 and a configuration icon 716; and registered devices 725 provisioned through a non-mobile network platform (e.g., a broadband network) that are available for content transaction(s) with a mobile network platform (e.g., mobile network platform 140) and among mobile and non-mobile devices which can also be presented in 725. Illustrative registered devices 725 include a mobile station 706 which can be registered with the mobile network platform through a client component 108 that resides within the mobile station 706 or via conventional means at the time the mobile station 706 is provisioned; a data storage unit 707; a personal computer 708 which can be a master non-mobile device; a VoIP telephone 709; and an IPTV interface 710. Appearance of registration icon 715 can be customized by an end user, or it can be set to an enterprise symbol that identifies a network operator that serves the networked devices 725. Registration icon 716 also can be customized. Registration icon 715 and configuration icon 716 can be actuated through various navigation gestures, such as one or more mouse or joystick clicks, a tap in case rendering area 705 is a touch screen, a hover of an object such as an end user's hand, etc. In an aspect, actuation of configuration icon 716 can lead to a navigation display (e.g., DUI 730 or DUI 760) that facilitates access to content available for transactions. In another aspect, actuation of registration icon 715 can display a navigation screen (e.g., DUI 730) that includes provisioned non-mobile devices that can be registered with a mobile network platform. Actuation can be effected after a secure authentication (e.g., digital authentication, or biometric authentication) in order to introduce a layer of security to prevent access of unauthorized agents to a navigation display for content transaction(s).

FIG. 7B illustrates diagram 730 of an example DUI that includes a rendering area 705 that displays a registration icon 715 and configuration icon 515, and contents 736-740 available for a set of respective registered devices. Alternatively, DUI 730 can render a set of non-mobile devices that can be registered with a mobile network platform 741. In an aspect, DUI 735 can embody a navigation display for DUI 700 that facilitates content transaction(s) or non-mobile device(s) configuration. Contents 736-740 associated with various registered devices can be accessed via various gestures (e.g., click, touch, voice command . . . ); or downloaded via drag-and-drop gestures to the device that operates DUI 730. In addition, content source(s) in mobile network platform 741, e.g., a first source 742 illustrates as a hexagon and a second disparate source 743 illustrated as a triangle, can be accessed through DUI 730. Moreover, content(s) that reside in the device that operates DUI 730 can be uploaded through drag-and-drop operations.

FIG. 7C is a diagram 760 of an example DUI that includes a rendering area 705 that displays a registration icon 715 and configuration icon 716, and contents of a registered non-mobile device, e.g., data server 707, and a mobile station 706 that are available for content transaction(s). In an aspect, DUI 760 can be an alternative, or additional, navigation display for DUI 700 that facilitates content transaction(s). In DUI 760, contents in registered non-mobile device(s), and mobile devices as well are displayed in tree structures. Contents in a tree structure can be arranged in accordance with logical structure of the contents, to provide with a logical representation of available content (e.g., a file system). As an example, for registered non-mobile device 707, a tree 767 presents three root nodes, which can represent work related contents (e.g., right-hatched node), personal contents (e.g., left-hatched node), and content that needs substantial attention (e.g., cross-hatched node), like a commonly termed “to-do list.” Category nodes (e.g., solid circles) represents groups of logically related contents (e.g., movies, reports, and so on), while leafs (e.g., open circle nodes) of a content-tree can be specific files that correspond to a category node. A similar tree representation 766 of content in mobile station 706 can be rendered. At least one advantage of a tree representation of content is that content structure generally can be device dependent (e.g., file system structure of a PC computer can be substantially different than structure of recorded content units in a DVR), thus a tree structure can provide for an intuitive representation that is device independent and enhances simplicity of content transfer and manipulation.

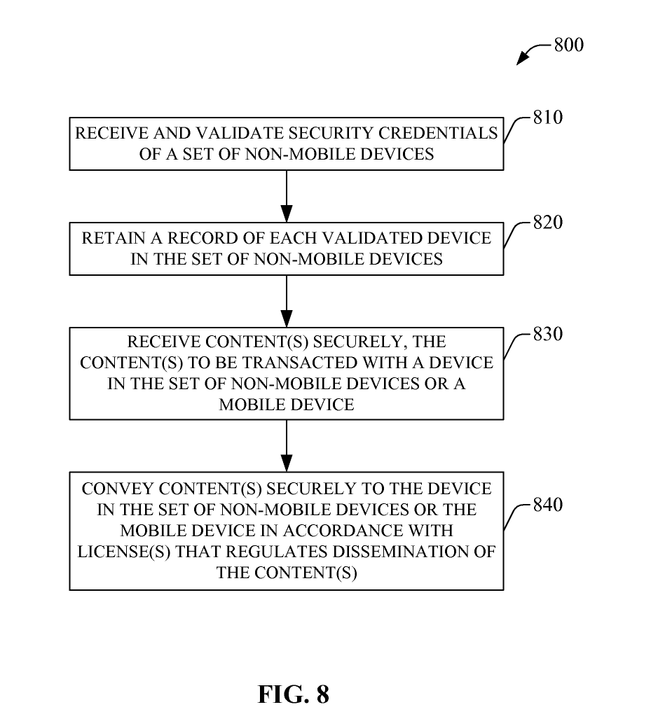

In view of the example systems described above, example methodologies that can be implemented in accordance with the disclosed subject matter can be better appreciated with reference to flowcharts in FIGS. 8-12. For purposes of simplicity of explanation example methodologies, or methods, are presented and described as a series of acts; however, it is to be understood and appreciated that the claimed subject matter is not limited by the order of acts, as some acts may occur in different orders and/or concurrently with other acts from that shown and described herein. For example, it is to be understood and appreciated that a methodology could alternatively be represented as a series of interrelated states or events, such as in a state diagram, or interaction diagram. Moreover, not all illustrated acts may be required to implement a methodology in accordance with the subject specification. Additionally, it should be further appreciated that the methodologies disclosed hereinafter and throughout this specification are capable of being stored on an article of manufacture to facilitate transporting and transferring such methodologies to computers for execution by a processor or for storage in a memory.

FIG. 8 is a flowchart of an example method 800 for recording non-mobile devices to conduct content transaction(s) according to aspects described herein. In aspect, a set of non-mobile devices is registered with a mobile network platform (see FIG. 1); devices in the set of non-mobile devices can be any of the devices described in connection with example system 100. This example method 800 can be implemented through a component that resides within the mobile network platform. At act 810, security credentials of a set of non-mobile devices are received and validated. In an aspect, security credentials can include at least one of passwords, encryption keys, biometric labels, or instruments, such as fingerprint(s) or iris pattern, voice profile, or any combination thereof. Validation of credentials can occur according to various security protocols such as for example Internet Protocol Security (IPsec), Secure Socket Layer (SSL), Transport Layer Security (TLS), Secure Shell (SSH), Secure File Transport Protocol (SFTP), Secure Copy (SCP), biometric locking (e.g., information access through an authorized or registered biometric instrument), and so forth. At act 820, a record of each validated device is retained. The record can include at least one of a registration marker, identifying non-mobile device information, or technical specification(s) of the non-mobile device. At act 830, content(s) to be transacted with a device in the set of non-mobile devices are received securely. Content(s) can be received from a non-mobile device within the set of non-mobile devices, a mobile device served through the mobile network platform, or an application executed in a service node in a service network (e.g., a telephony network, an IP multimedia subsystem, an Internet service provider, an enterprise local area network, and so forth). At act 840, content(s) are conveyed securely to the device in the set of non-mobile devices or the mobile device according to one or more licenses that regulate dissemination of the content(s). In an aspect, content can include streaming multimedia (e.g. video streaming or sound streaming) or pre-recorded media files (e.g., photos in Joint Photographic Experts Group (JPEG) format), text-based protected or unprotected files, etc. It should be appreciated that security aspects, or features, of content(s) delivery are derived from security protocol(s) utilized to validate security credentials of a set of non-mobile devices. As an example, content(s) can be tunneled via a VPN established via to one or more of the foregoing security protocols.

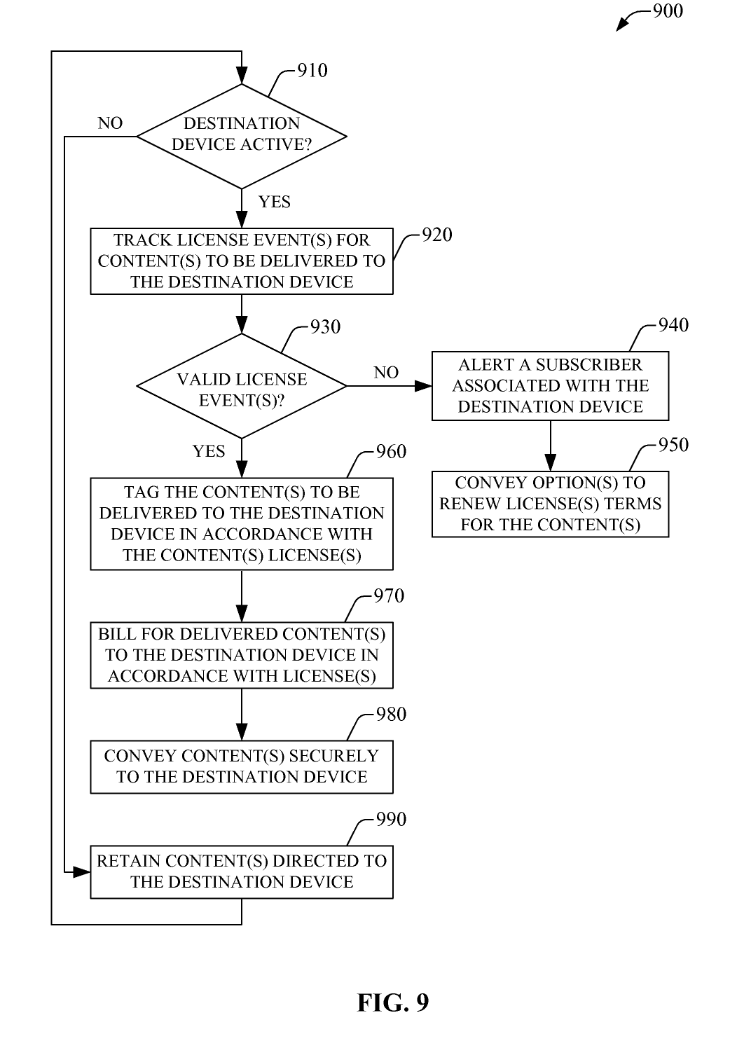

FIG. 9 is a flowchart of an example method 900 for delivering licensed contents to a destination device according to aspects described herein. This example method can be utilized in conjunction with example method 800. In an aspect, example method 900 can be enacted through a component (e.g., license manager component 155) in a mobile network platform that registers mobile and non-mobile devices, which can be destination devices for content(s). At act 910, it is checked whether a destination device (e.g., master non-mobile device 105_{J}) is active. When a device is not active, content(s) directed to the destination device are retained at act 990. For example, content(s) can be retained in a content storage in a memory element. Conversely, when the destination device is active, license event(s) for content(s) to be delivered to a destination device are tracked at act 920. Valid license event(s) are verified at act 930. Invalid license event(s), e.g., copies of content(s) to be conveyed are outside the scope of the license, result in a subscriber associated with the destination device being alerted accordingly at act 940. At act 950, option(s) to renew license(s) terms for the content(s) are conveyed. When license event(s) are valid, content(s) to be delivered to a destination device are tagged in accordance with the content(s) license(s) at act 960. At act 970, billing charges for delivered content(s) to the destination device are effected, or issued, according to content(s) license(s). It should be appreciated that for license-free content(s), e.g., disseminated through GNU GPL agreement, charges are null. At act 980, content(s) are conveyed securely to the destination device.

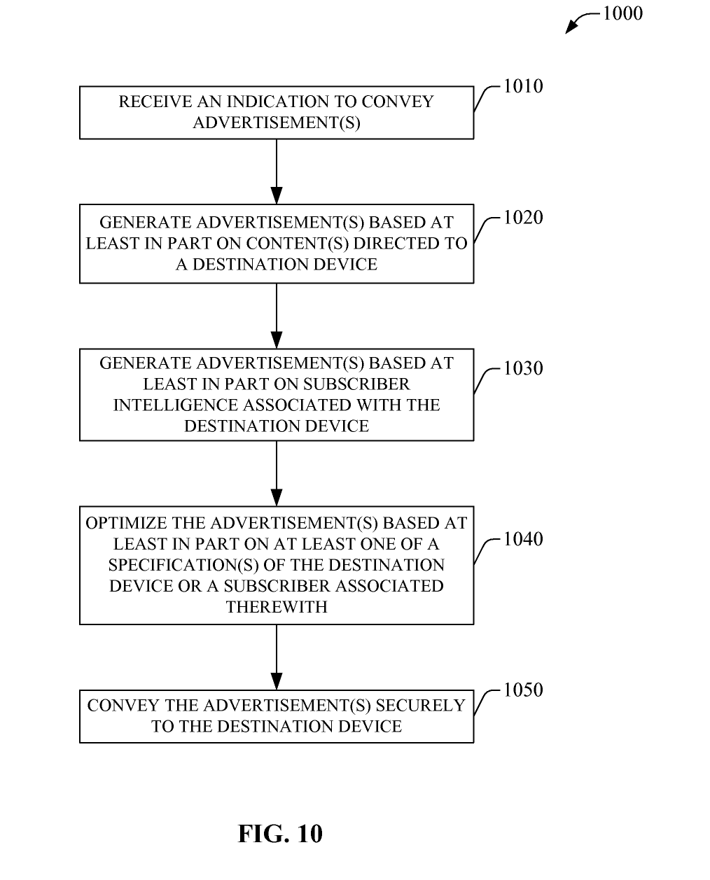

FIG. 10 is a flowchart of an example method 1000 for pushing, or delivering, advertisement(s) to a destination device according to aspects described herein. A destination device can be a registered non-mobile device (e.g., device J 105_{J}) or a mobile device (e.g., mobile 180). At act 1010, an indication to convey advertisement(s) is received. The indication can be received within a signaling packet (e.g., signaling 117) with a predefined format (e.g., number of bits). In an aspect, a destination device can convey the indication in response to a configuration directive. At act 1020, advertisement(s) is generated based at least in part on content(s) directed to a destination device. In an aspect, advertisement(s) can be generated by a mobile network platform (see FIG. 1). At act 1030, advertisement(s) is generated based at least in part on subscriber intelligence (e.g., subscriber demographics, historic data on content transaction(s), utilization and consumption of content(s) generated through service node or application within service network(s) . . . ) associated with the destination device. At act 1040, advertisement(s) is optimized based at least in part on one of the destination device or a subscriber associated therewith. At act 1050, advertisement(s) is conveyed to the destination device. The advertisement(s) can be delivered securely as either a part of transacted content(s) (e.g., content(s) 116) or in a stand-alone manner (e.g., decouple from content(s)) tunneled to a device without associated content(s). It should be appreciated that security aspects, or features, of advertisement(s) delivery are derived from security protocol(s) utilized to validate security credentials of a set of non-mobile devices, as described hereinbefore.

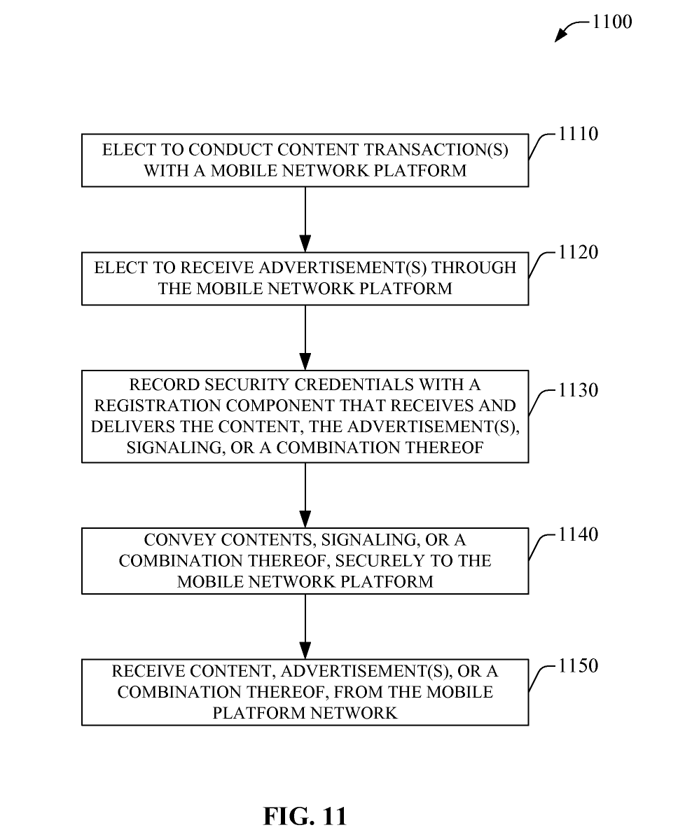

FIG. 11 is flowchart of an example method 1100 for registering and conducting content transaction(s) with a mobile network platform according to aspects described herein. In an aspect this example method can be enacted by a non-mobile device provisioned through a non-mobile network platform (e.g., a broadband network). At act 1110, it is elected to conduct transaction(s) with a mobile network platform. Such election can be effected via a provisioning server at a time a non-mobile device is provisioned, or by a master device upon configuration of slave non-mobile device. Election can be conveyed to the mobile network platform through signaling 117, and can result in creation of security credentials for the non-mobile device. At act 1120, it is elected to receive advertisement(s) through the mobile network platform. At act 1130, security credentials are recorded with a registration component that receives and delivers the content, the advertisement(s), signaling, or a combination thereof. The registration component can reside within the mobile network platform. Credentials, or security credentials, are associated with one or more provisioned non-mobile devices, the credentials can include at least one of passwords, encryption keys, biometric labels, or instruments, such as fingerprint(s) or iris pattern, voice profile, or any combination thereof. To record the credentials, such credentials are conveyed to the registration component and validated thereby. Validation can occur according to various security protocols such as for example Internet Protocol Security (IPsec), Secure Socket Layer (SSL), Transport Layer Security (TLS), Secure Shell (SSH), Secure File Transport Protocol (SFTP), Secure Copy (SCP), biometric locking (e.g., information access through an authorized or registered biometric instrument), and so forth. At act 1140, content, signaling, or a combination thereof, are conveyed securely to the mobile network platform. At act 1150, content, advertisement(s), or a combination thereof, are received securely from the mobile platform network. It should be appreciated that security aspects, or features, of delivery and reception of content, signaling, or advertisement, are derived from security protocol(s) utilized to record the set of non-mobile devices with the registration component.

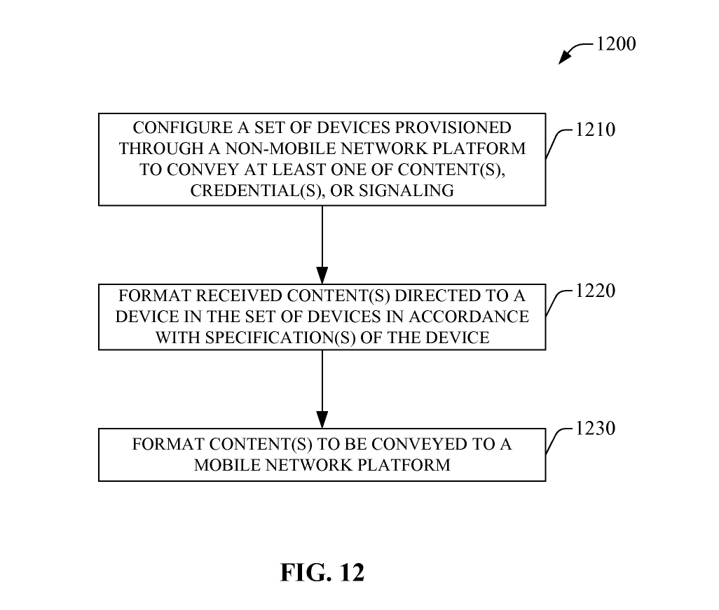

FIG. 12 is a flowchart of an example method 1200 for exchanging content(s) transacted with a mobile network platform according to aspects described herein. It should be noted that this example method can be utilized in conjunction with example method 1100. At act 1210, a set of devices provisioned through a non-mobile network platform is configured to convey at least one of content(s), credential(s), or signaling. Configuration can include a master-device-slave-device scheme, as described above in connection with example system 100. Configuration of a master device can be implemented at a time of provisioning a first non-mobile device. Slave non-mobile devices can be provisioned via the master non-mobile device. At act 1220, received content(s) directed to a device in the set of devices is formatted in accordance with technical specifications of the device. Formatting content(s) can include format conversion, bitrate adjustment, downsampling and upsampling of content(s), and so forth. At act 1230, content(s) to be conveyed to a mobile network platform are formatted. The network platform typically has recorded or registered a set of non-mobile device which can convey content thereto.

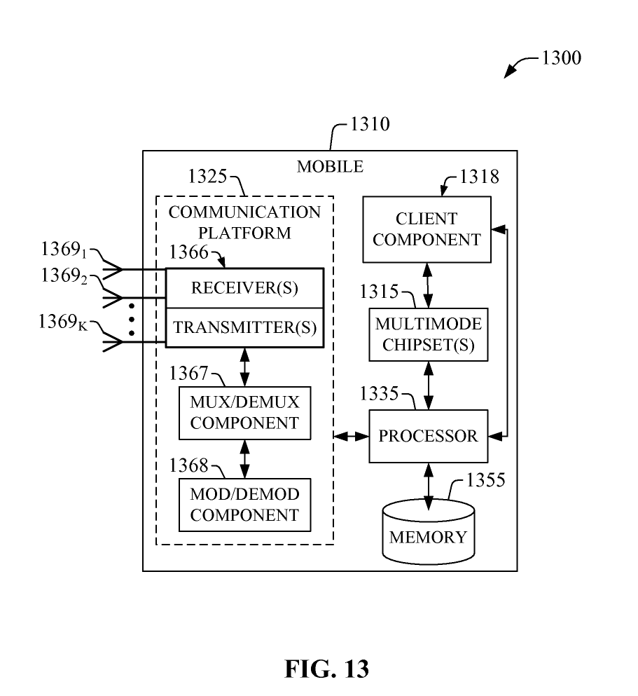

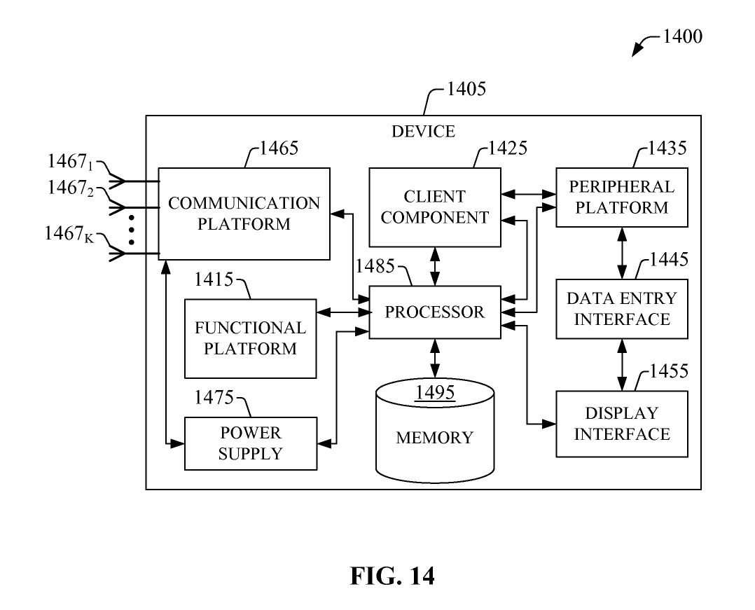

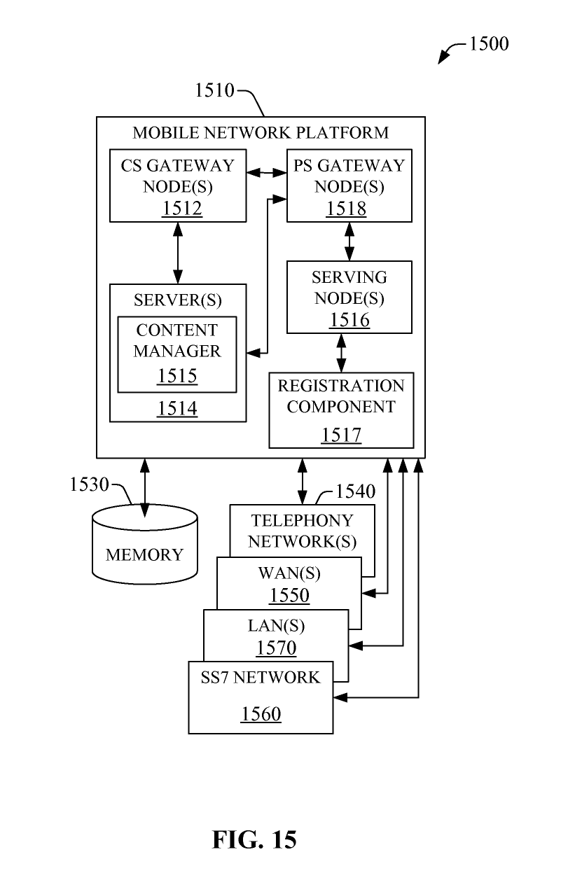

To provide further context for various aspects of the subject specification, FIG. 13 illustrates a block diagram of an example embodiment 1300 of a mobile 1410 that can exchange content(s) with a non-mobile device registered with a mobile network platform in accordance with aspects described herein. Additionally, FIG. 14 presents a block diagram of an example embodiment 1400 of a non-mobile device 1405, which can be provisioned through a non-mobile network platform, and can operate as either a master device or a slave device is accordance with aspects described herein. Furthermore, FIG. 15 presents an example embodiment 1500 of a mobile network platform 1510 which can register non-mobile devices and administer content transaction(s) in accordance with aspects described herein.

In mobile 1310, which can be a multimode access terminal, a set of antennas 1369₁-1369_{K} (K is a positive integer) can receive and transmit signal(s) from and to wireless devices like access points, access terminals, wireless ports and routers, and so forth, that operate in a radio access network, e.g., RAN 185. It should be appreciated that antennas 1369₁-1369_{K} are a part of communication platform 1325, which comprises electronic components and associated circuitry that provide for processing and manipulation of received signal(s) and signal(s) to be transmitted. In an aspect, communication platform 1325 includes receiver(s)/transmitter(s) 1366 that can convert signal from analog to digital upon reception, and from digital to analog upon transmission. In addition, receiver/transmitter 1366 can divide a single data stream into multiple, parallel data streams, or perform the reciprocal operation; such operations typically conducted in various multiplexing schemes. Functionally coupled to receiver(s)/transmitter(s) 1366 is a multiplexer/demultiplexer (mux/demux) component 1367 that facilitates manipulation of signal in time and frequency space. Electronic mux/demux component 1367 can multiplex information (data/traffic and control/signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition, mux/demux component 1367 can scramble and spread information (e.g., codes) according to substantially any code; e.g., Hadamard-Walsh codes, Baker codes, Kasami codes, polyphase codes, and so on. A modulator/demodulator (mod/demod) component 1368 is also a part of communication platform 1325, and can modulate information according to various modulation techniques, such as frequency modulation (e.g., frequency-shift keying), amplitude modulation (e.g., M-ary quadrature amplitude modulation (QAM), with M a positive integer; amplitude-shift keying (ASK)), phase-shift keying (PSK), and the like. In an aspect of embodiment 1300, mod/demod component 1368 is functionally coupled to mux/demux component 1367.

In embodiment 1300, multimode operation chipset(s) 1315 allows mobile 1310 to operate in multiple communication modes in accordance with disparate technical specification for wireless technologies. In an aspect, multimode operation chipset(s) 1315 utilizes communication platform 1325 in accordance with a specific mode of operation. In another aspect, multimode operation chipset(s) 1315 can be scheduled to operate concurrently (e.g., when N>1) in various modes or within a multitask paradigm.

Mobile 1310 can include client component 1318 which operates in substantially the same manner as client component 108, and can convey content(s) and signaling securely in accordance with aspects described in the subject specification. It should be appreciated that content(s) and signaling can also be conveyed through conventional wireless communication, without encapsulation in a security layer as can be provided through client component 1318.

Mobile 1310 also includes a processor 1335 configured to confer functionality, at least in part, to substantially any electronic component within mobile 1310, in accordance with aspects of the subject innovation. As an example, processor 1335 can be configured to execute, at least in part, instructions in multimode operation chipset(s) that afford multimode communication through mobile 1310 like concurrent or multitask operation of two or more chipset(s). As another example, processor 1335 can facilitate mobile 1510 to receive traffic (e.g., various data flows) through security protocol(s) established through client component 1318, and relay such traffic via communication platform 1325. As yet another example, processor 1335 can receive synchronization indications via extension interface 1318 to maintain content synchronized with operation performed in a device (not shown) attached to mobile 1310 via extension interface 1318. A link dock 1319 can be operationally coupled to extension interface 1319 to facilitate attachment of link component(s) that are at least a part of extension interface 1319. It should be appreciated that processor 1335 can store (e.g., in cache memory) at least temporarily traffic received from either extension interface 1318 or communication platform 1325, or both. Moreover, processor 1335 facilitates mobile 1310 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. Memory 1355 can store data structures (e.g., metadata); code structure(s) (e.g., modules, objects, classes, procedures) or instructions; network or device information like policies and specifications, attachment protocols; code sequences for scrambling, spreading and pilot (e.g., reference signal(s)) transmission; frequency offsets, cell IDs, and so on.

In embodiment 1300, processor 1335 is functionally coupled (e.g., through a memory bus) to memory 1355 in order to store and retrieve information necessary to operate and/or confer functionality, at least in part, to communication platform 1325, multimode operation chipset(s) 1315, extension interface 1318, and other operational aspects of multimode mobile 1310.

FIG. 14 is a block diagram of an example embodiment 1400 of a non-mobile device that can register with a mobile platform network, and can exploit various aspects of content transaction(s) as described herein. Device 1405 includes a functional platform 1415 that comprises a set of components that provide, at least in part, one or more specific functionalities of the non-mobile device 1405. Additionally, non-mobile device 1405 includes a client component 1425 in accordance with aspects described herein. Moreover, in an aspect, non-mobile device 1405 can include a communication platform 1465 that can provide wireless communication capabilities in addition, or alternatively, to connectivity of non-mobile device 1405 through wired links (e.g., Ethernet, USB, GPIB, RS-232, FireWire, optical or coaxial cable connection to a network interface such as network interface 115, or router (not shown)). With respect to wireless capability, in non-mobile device 1405, which can be a multimode access terminal, a set of antennas 1467₁-1467_{K} (K is a positive integer) can receive and transmit signal(s) from and to wireless devices like access points, access terminals, wireless ports and routers, etc., that operate in a radio access network (e.g., RAN 185). Communication platform 1465 can exploit the set of K antennas 1457₁-1457_{K}, (K is a positive integer) to establish communication within various modes such as single-input single-output, or multiple-input multiple output. Communication platform 1465 operates in substantially the same manner as communication platform 1325.

Additionally, in non-mobile device 1405, a peripheral component 1435 can include, or facilitate connection to, additional devices such as printer(s), media player(s), wireless router(s) (e.g., network interface 115), biometrics touch-pad(s), etc. In an aspect, to afford such connectivity, peripheral component 1435 can include jacks for one or more of Ethernet, USB, GPIB, RS-232, FireWire, optical or coaxial cable connectors. Additionally, display interface 1455 can be a part of functional platform 1415 (e.g., when non-mobile device 1405 is a PC, an IPTV interface, a mobile, a backprojector component, a data projector . . . ), or it also can be a part of interface component 515 or interface component 555. Display interface 1455 also can display functions that control functionality of device 1405, or reveal operation conditions thereof (e.g., light-emitting-diode (LED) indicator(s) of non-mobile devices registered with a mobile network and available for content transaction(s)). For example, display interface 1455 can display at least one of a graphical user interface (e.g., DUI 700, 730, or 760) to navigate and effect content transaction(s) across registered non-mobile devices provisioned through a non-mobile network platform, or configuration of non-mobile devices, in accordance with aspects described in the subject specification. In an aspect, display interface 1455 can be a liquid crystal display (LCD), a plasma panel, a monolithic thin-film based electrochromic display, and so on.

It should be appreciated that non-mobile device 1405 also can include a data entry interface 1445 that can allow an end user to perform at least one of (i) command non-mobile device 1405 via configuration of functional platform 1415, (ii) interact with a provisioning non-mobile network platform (e.g., an enterprise network platform) or with a mobile network platform, particular a component that registers devices with the mobile network platform to conduct content transaction(s) through non-mobile device 1405, or (iii) generate content(s) (e.g., images via a built-in camera) or directive(s) for networked content management.

Power supply 1475 can power-up device 1405 and substantially any component included thereon. It should be appreciated that alternative or additional embodiments of device 1405 may not include power supply 1475 and be powered via an attachment to a conventional power grid.

In embodiment 1400, non-mobile device 1405 includes processor 1485 which can be functionally coupled (e.g., through a memory bus) to memory 1495 in order to store and retrieve information necessary to operate and/or confer functionality, at least in part, to client component 1425, and substantially any component thereon in accordance with aspects described herein; functional platform 1415, communication platform 1465 when non-mobile device 1405 includes it; and substantially any other component of non-mobile device 1405. With respect to client component 1425, and components thereon, processor 1485 can be configured to execute security protocols to convey credentials and securely exchange content(s) with a mobile network platform, or securely convey contents to a disparate device. In addition, in connection with communication platform 1465, mobile 1410 also includes a processor 1435 configured to confer functionality, at least in part, to substantially any electronic component within mobile 1410, in accordance with aspects of the subject innovation. As an example, processor 1435 can be configured to execute, at least in part, instructions in multimode operation chipset(s) that afford multimode communication through mobile 1410 like concurrent or multi-task operation of two or more chipset(s). It should be appreciated that processor 1435 can store (e.g., in cache memory) at least temporarily traffic received from communication platform 1425, or both. Moreover, processor 1435 facilitates mobile 1410 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc.

Memory 1455 can store data structures (e.g., metadata); code structure(s) (e.g., modules, objects, classes, procedures) or instructions, or substantially any type of software or firmware that processor 1485 can execute to provide functionality associated with functional platform 1415; network or device information like policies and specifications; code sequences for scrambling, spreading and pilot (e.g., reference signal(s)) transmission; and so on. Additionally, memory 1495 also can retain content(s) (e.g., multimedia files), historic data on content transaction(s), security credentials (e.g., passwords, encryption keys, digital certificates, biometric reference indicators like voice recordings, iris patterns, fingerprints), etc.

As indicate supra, FIG. 15 presents an example embodiment 1500 of a mobile network platform 1510 which can register non-mobile devices and administer content transaction(s) in accordance with aspects described herein. Generally, mobile network platform 1510 can include components, e.g., nodes, gateways, interfaces, servers, or platforms, that facilitate both packet-switched (PS) (e.g., internet protocol (IP), frame relay, asynchronous transfer mode (ATM)) and circuit-switched (CS) traffic (e.g., voice and data) and control generation for networked wireless communication. In an aspect of the subject innovation, mobile network platform 1510 includes CS gateway node(s) 1512 which can interface CS traffic received from legacy networks like telephony network(s) 1540 (e.g., public switched telephone network (PSTN), or public land mobile network (PLMN)) or a SS7 network 1560. Circuit switched gateway node(s) 1512 can authorize and authenticate traffic (e.g., voice) arising from such networks. Additionally, CS gateway node(s) 1012 can access mobility, or roaming, data generated through SS7 network 1560; for instance, mobility data stored in a visitation location register (VLR), which can reside in memory 1530. Moreover, CS gateway node(s) 1512 interfaces CS-based traffic and signaling and gateway node(s) 1018. As an example, in a 3GPP UMTS network, CS gateway node(s) 1512 can be embodied, at least in part, in gateway GPRS support node(s) (GGSN). In an aspect, CS gateway node(s) can embody, at lease in part, gateway node(s) 165.

In the subject innovation, in addition to receiving and processing CS-switched traffic (e.g., content(s) that can be part of a content transaction) and signaling, PS gateway node(s) 1518 can authorize and authenticate PS-based data sessions with served (e.g., through RAN 185) mobile devices, or with recorded non-mobile devices which can be recorded through registration component 1517. Such registration component 1517 operates in substantially the same manner as registration component 145 as described hereinbefore. Data sessions can include traffic, or content(s), exchange with networks external to the mobile network platform 1010, like wide area network(s) (WANs) 1550; it should be appreciated that local area network(s) (LANs) 1570 can also be interfaced with mobile network platform 1510 through PS gateway node(s) 1518. It is to be noted that WANs 1550 and LANs 1570 can embody, at least in part, service network(s) 170. Packet-switched gateway node(s) 1518 generates packet data contexts when a data session is established. To that end, in an aspect, PS gateway node(s) 1518 can include a tunnel interface (e.g., tunnel termination gateway (TTG) in 3GPP UMTS network(s) (not shown)) which can facilitate packetized communication with disparate wireless network(s), such as Wi-Fi networks. It should be further appreciated that the packetized communication can include multiple flows that can be generated through service (e.g., provisioning) and application server(s) 1514. It is to be noted that in 3GPP UMTS network(s), PS gateway node(s) 1018 (e.g., GGSN) and tunnel interface (e.g., TTG) comprise a packet data gateway (PDG). In an aspect, PS gateway node(s) 1518 can embody, at lease in part, gateway node(s) 165.

In embodiment 1500, mobile network platform 1510 also includes serving node(s) 1516 that convey the various packetized flows of data streams (e.g., content(s) that are part of content transaction(s)), received through PS gateway node(s) 1518. As an example, in a 3GPP UMTS network, serving node(s) 1516 can be embodied in serving GPRS support node(s) (SGSN). In an aspect, serving node(s) 1516 can embody, at least in part, service network(s) 170.

Server(s) 1514 in mobile network platform 1510 can execute numerous applications (e.g., location services, online gaming, wireless banking, wireless device management . . . ) that can generate multiple disparate packetized data streams or flows, and manage (e.g., schedule, queue, format . . . ) such flows. Such application(s), for example can include add-on features to standard services provided by mobile network platform 1510. Data streams (e.g., content(s) that are part of a content transaction) can be conveyed to PS gateway node(s) 1518 for authorization/authentication and initiation of a data session, and to serving node(s) 1516 for communication thereafter. As discussed above, PS gateways node(s) 1518 can convey the data streams (e.g., content(s)) to a registered non-mobile device (e.g., device J 105_{J}). Server(s) 1514 can also effect security (e.g., implement one or more firewalls) of mobile network platform 1510 to ensure network's operation and data integrity in addition to authorization and authentication procedures that CS gateway node(s) 1512 and PS gateway node(s) 1518 can enact. Moreover, server(s) 1514 can provision services from external network(s), e.g., WAN 1550, or Global Positioning System (GPS) network(s) (not shown). It is to be noted that server(s) 1514 can include one or more processor configured to confer at least in part the functionality of macro network platform 1510. To that end, the one or more processor can execute code instructions stored in memory 1530, for example. It is should be appreciated that server(s) 1514 can include a content manager 1515, which operates in substantially the same manner as described hereinbefore. Server(s) 1514 also can include an advertisement component (not shown) that provides substantially the same functionalities as advertisement component 405. Furthermore, server(s) 1514 can embody, at least in part, service network(s) 170.

In example wireless environment 1500, memory 1530 can store information related to operation of mobile network platform 1510. Information can include provisioning information of devices served directly through the mobile platform network 1510 or via registration component 1517; records of registered non-mobile devices (e.g., 105₁-105_{J}); subscriber intelligence; pricing schemes, e.g., promotional rates, flat-rate programs, couponing campaigns; technical specification(s) of non-mobile devices recorded with the mobile network platform; and so forth. Memory 1530 can also store information from at least one of telephony network(s) 1540, WAN 1550, LAN 1570, or SS7 network 1560.

Various aspects or features described herein may be implemented as a method, apparatus, or article of manufacture using standard programming and/or engineering techniques. In particular, the aspects or features can be implemented through program modules stored in a memory and executed by a processor, and/or other combination of hardware and software, e.g., firmware. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” data storage,” “database,” and substantially any other information storage component relevant to operation and functionality of a component, refer to “memory components,” or entities embodied in a “memory” or components comprising the memory. For example, information relevant to operation of various components described in the disclosed subject matter, and that can be stored in a memory, can comprise provisioning information; security credentials and algorithms; files and applications; policies such as alarm(s) criteria and alarm reports; and so forth. It is to be appreciated that the memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of systems and methods that provide advantages of the subject innovation. It is, of course, not possible to describe every conceivable combination of components or methodologies for purposes of describing the subject innovation, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method for registering with a mobile network platform and transacting content(s) therewith, the method comprising:
electing to conduct a content transaction with the mobile network platform;
recording a security credential with the mobile network platform;
conveying content(s) securely to the mobile network platform as part of the content transaction; and
receiving content(s) securely from the mobile network platform as part of the content transaction.

2. The method of claim 1, wherein electing to conduct a content transaction includes conveying signaling to create a security credential.

3. The method of claim 2, wherein recording a security credential with the mobile network platform comprises:
conveying the security credential; and
validating the security credential according to a security protocol, the security protocol includes at least one of an Internet Protocol Security (IPsec), a Secure Socket Layer (SSL), a Transport Layer Security (TLS), a Secure Shell (SSH), a Secure File Transport Protocol (SFTP), a Secure Copy (SCP), or a biometric locking.

4. The method of claim 3, wherein a security credential includes at least one of a password, an encryption key, or a digital certificate.

5. The method of claim 4, wherein conveying content(s) securely to the mobile network platform as part of the content transaction includes configuring a set of non-mobile devices provisioned through a non-mobile network platform to convey at least one of content(s), credential(s), or signaling.

6. The method of claim 5, wherein content(s) includes at least one of streaming or pre-recorded multimedia.

7. The method of claim 6, further comprising formatting content(s) to be conveyed as a part of the content transaction.

8. The method of claim 7, wherein receiving content(s) securely from the mobile network platform as part of the content transaction includes formatting received content(s) directed to a device according to technical specification(s) of the device.

9. The method of claim 8, wherein formatting at least one of received content(s) or content(s) to be conveyed includes at least one of upconverting a content(s) resolution, dowconverting a content(s) resolution, altering a content(s) bitrate.

10. The method of claim 2, further comprising:
electing to receive advertisement(s) from the mobile network platform; and
receiving securely at least one of advertisement(s) or content(s) as a part of a content transaction.

11. The method of claim 10, wherein the set of non-mobile devices includes wireless devices and tethered devices, and the set of non-mobile devices operate in one of a home-based environment, an industrial environment, or a health care environment.

12. A system for remote content management, the system comprising:
a set of non-mobile devices provisioned through a non-mobile network platform;
a configuration component that configures at least one device within the set of provisioned non-mobile devices as one of a master device or a slave device, the configuration component resides within one or more devices in the set of provisioned non-mobile devices; and
a client component that registers one or more devices in the set of non-mobile devices with a mobile network platform to conduct content transaction(s) therewith, the client component resides within a non-mobile device configured as a master device.

13. The system of claim 12, wherein the client component securely receives content(s) from a securely conveys content(s) to the mobile network platform.

14. The system of claim 13, the client component further receives and delivers signaling.

15. The system of claim 14, wherein the content transaction(s) includes at least one of secure content(s) access or secure content(s) exchange with at least one of a registered non-mobile device, a mobile device, or the mobile network platform, the content(s) includes at least one of streaming or pre-recorded multimedia.

16. The system of claim 15, wherein the master device includes a configuration component that configures a registered non-mobile device as a slave device.

17. The system of claim 16, the client component includes a security component that effects a security protocol to securely receive or deliver at least one of content(s), security credential(s), or signaling.

18. The system of claim 17, wherein the security protocol includes at least one of an Internet Protocol Security (IPsec), a Secure Socket Layer (SSL), a Transport Layer Security (TLS), a Secure Shell (SSH), a Secure File Transport Protocol (SFTP), a Secure Copy (SCP), or a biometric locking.

19. The system of claim 18, the client component retains a set of security credentials and security protocols to receive or deliver at least one of content(s) or signaling.

20. The system of claim 19, the security credentials include at least one of a password, an encryption key, or a digital certificate.

21. The system of claim 20, further comprising a display user interface that conveys a set of devices available for content transaction(s), the set of devices includes at least one registered non-mobile device and at least one mobile device.

22. The system of claim 21, further comprising a format component that manipulates at least one of received content(s) or content(s) to be conveyed, the format component effects at least one of upconversion or downconversion of a content(s) resolution, or alters a content(s) bitrate.

23. The system of claim 22, the display user interface conveys a set of devices available for one of registration or configuration.

24. The system of claim 23, the interface component includes a display user interface that conveys content(s) available for content transaction(s) when an icon is actuated.

25. The system of claim 24, the display user interface conveys services that can provide content(s) for a content transaction(s).

26. The system of claim 25, the set of non-mobile devices includes at least one of wireless devices or tethered devices, wherein the at least one of mobile devices or tethered devices operate in one of a home-based environment, an industrial environment, or a health care environment.

27. A computer-readable storage medium comprising code instructions that, when executed by at least one processor, carry out the following acts:
electing to conduct a content transaction with the mobile network platform;
recording a security credential with the mobile network platform;
electing to receive advertisement(s) from the mobile network platform;
conveying securely at least one of content(s) or advertisement(s) to the mobile network platform as part of the content transaction; and
receiving content(s) securely from the mobile network platform as part of the content transaction.

28. The computer-readable storage medium of claim 27, further comprising code instructions that, when executed by the at least one processor, carry out the following acts:
conveying the security credential; and
validating the security credential according to a security protocol, the security protocol includes at least one of an Internet Protocol Security (IPsec), a Secure Socket Layer (SSL), a Transport Layer Security (TLS), a Secure Shell (SSH), a Secure File Transport Protocol (SFTP), a Secure Copy (SCP), or a biometric locking.

29. The computer-readable storage medium of claim 28, further comprising code instructions that, when executed by the at least one processor, carry out the acts of configuring a set of non-mobile devices provisioned through a non-mobile network platform to convey at least one of content(s), credential(s), or signaling.

30. A method for conducting content transaction(s), the method comprising:
receiving and validating security credentials of a set of non-mobile devices;
retaining a record of each validated device in the set of non-mobile devices;
receiving content(s) securely, the content(s) to be transacted with one of a device in the set of non-mobile devices or a mobile device; and
conveying content(s) securely to one of the device in the set of non-mobile devices or the mobile device according with a license that regulates dissemination of the content(s).

31. The method of claim 30, wherein the security credentials include at least on of a password, an encryption key, a digital certificate, or a biometric instrument.

32. The method of claim 31, wherein validating security credentials occurs according to one or more security protocols, the security protocols include at least one of an Internet Protocol Security (IPsec), a Secure Socket Layer (SSL), a Transport Layer Security (TLS), a Secure Shell (SSH), a Secure File Transport Protocol (SFTP), a Secure Copy (SCP), or a biometric locking.

33. The method of claim 32, wherein conveying content(s) securely to one of the devices in the set of non-mobile devices or the mobile device according with a license that regulates dissemination of the content(s) includes:
tracking license events for the content(s) to be delivered when a destination device is active;
tagging the content(s) to be delivered in accordance with the license that regulates dissemination of the content(s) when the license events are valid;
billing for delivered content(s) to the destination device in accordance with the license that regulates dissemination of the content(s); and
conveying the content(s) securely to the destination device.

34. The method of claim 33, further comprising retaining the content(s) to be delivered when the destination device is inactive.

35. The method of claim 34, when the license event are invalid, further comprising:
alerting a subscriber associated with the destination device; and
conveying option(s) to renew the terms of the license that regulates dissemination of the content(s).

36. The method of claim 35, further comprising:
receiving an indication to convey advertisement(s);
generating the advertisement(s) based at least in part on content(s) directed to one of a registered non-mobile device or a mobile device; and
conveying the advertisement(s) securely to one of the registered non-mobile device or the mobile device.

37. The method of claim 36, further comprising generating the advertisement(s) based at least in part on subscriber intelligence associated with the one of the registered non-mobile device or the mobile device.

38. The method of claim 37, further comprising optimizing the advertisement(s) based at least in part on one of a specification of the one of the registered non-mobile device or the mobile device.

39. The method of claim 38, a biometric instrument includes at least one of fingerprint(s), iris pattern(s), or a voice profile.

40. A system, comprising:
a registration component that records a set of provisioned non-mobile devices, the component effects content transaction(s), wherein the content transaction(s) includes secure delivery of content(s) and secure reception of content(s); and
a content manager component that administers the content transaction(s) based at least in part on license term(s) that regulate content dissemination.

41. The system of claim 40, the content transaction(s) are conducted among a mobile network platform and a device within the set of recorded provisioned non-mobile devices.

42. The system of claim 41, further comprising a memory that retains registration record(s) of a recorded non-mobile device, wherein registration record(s) includes at least one of a recordation indication, identification information for the registered non-mobile device, or technical specifications of the registered non-mobile device.

43. The system of claim 42, wherein to record the set of provisioned non-mobile devices, the registration component receives and validates a set of security credentials associated with each device in the set of provisioned non-mobile devices.

44. The system of claim 43, wherein security credentials include at least one of passwords, encryption keys, digital certificates, or biometric labels.

45. The system of claim 44, wherein validation of credentials occurs according to one or more security protocols, the security protocols include at least one of an Internet Protocol Security (IPsec), a Secure Socket Layer (SSL), a Transport Layer Security (TLS), a Secure Shell (SSH), a Secure File Transport Protocol (SFTP), a Secure Copy (SCP), or a biometric locking.

46. The system of claim 45, wherein the registration component generates security credentials based upon an indication a provisioned non-mobile device elects to conduct content transaction(s)

47. The system of claim 46, wherein the content manager component receives content(s) from a set of service networks, the service networks include at least one of an application server or an internet protocol multimedia subsystem (IMS) network.

48. The system of claim 47, wherein the content manager component tracks license events for content(s) to be delivered in a content transaction.

49. The system of claim 48, further comprising a billing component that issues charges to a destination device for delivered content(s) in a content transaction in accordance with the license that regulates dissemination of the content(s).

50. The system of claim 49, wherein the billing component implements billing schemes based at least in part upon at least one of negotiated license rights to transacted content(s), on intelligence available on a subscriber associated with the destination device.

51. The system of claim 50, wherein the content manager component retains content(s) directed to a destination device the destination device is operationally inactive.

52. The system of claim 51, further comprising an advertisement component that injects advertisement(s) within a content transaction.

53. The system of claim 52, the advertisement component generates the advertisement(s) based at least in part on at least one of content(s) directed to one of a recorded non-mobile device or a mobile device, or subscriber intelligence associated with the one of the recorded non-mobile device or the mobile device.

54. The method of claim 53, the advertisement component further optimizes the advertisement(s) based at least in part on a technical specification of the recorded non-mobile device.

55. The system of claim 54 wherein the recordation indication is at least one of a predetermined multi-bit word in a specific memory register, or a recordation system file.

56. A computer-readable storage medium comprising code instructions that, when executed by at least one processor, carry out the following acts:
receiving and validating security credentials of a set of non-mobile devices;
retaining a record of each validated device in the set of non-mobile devices;
receiving content(s) securely, the content(s) to be transacted with one of a device in the set of non-mobile devices or a mobile device; and
conveying content(s) securely to one of the device in the set of non-mobile devices or the mobile device according with a license that regulates dissemination of the content(s).

57. The computer-readable storage medium of claim 56, further comprising code instructions that, when executed by the at least one processor, carry out the following acts:
tracking license events for the content(s) to be delivered when a destination device is active;
tagging the content(s) to be delivered in accordance with the license that regulates dissemination of the content(s) when the license events are valid;
billing for delivered content(s) to the destination device in accordance with the license that regulates dissemination of the content(s); and
conveying the content(s) securely to the destination device.

58. The computer-readable storage medium of claim 57, further comprising code instructions that, when executed by the at least one processor, carry out the following acts:
receiving an indication to convey advertisement(s);
generating the advertisement(s) based at least in part on content(s) directed to one of a registered non-mobile device or a mobile device;
conveying the advertisement(s) securely to one of the registered non-mobile device or the mobile device.
